(19) United States
(12) Patent Application Publication
(10) Pub. No.: US 2006/0125986 A1
(43) Pub. Date: Jun. 15, 2006

(54) Array substrate, method of manufacturing the same and liquid crystal display apparatus having the same

(76) Inventors: Dae-Ho Choo, Yongin-si (KR); Ho-Min Kang, Suwon-si (KR); Jae-Hoon Hwang, Seoul (KR); Jeong-Min Oh, Seoul (KR); Jung-Woo Park, Seoul (KR); Min-Sung Kwon, Hwaseong-si (KR); Dae-Seung Yun, Suwon-si (KR)

Correspondence Address: F. CHAU & ASSOCIATES, LLC, 130 WOODBURY ROAD, WOODBURY, NY, 11797, US

(21) Appl. No.: 11/299,595

(22) Filed: Dec. 12, 2005

(30) Foreign Application Priority Data
Dec. 13, 2004 (KR) 2004-104951
Feb. 4, 2005 (KR) 2005-10697
Feb. 5, 2005 (KR) 2005-10929

(51) Int. Cl. G02F 1/1335

(52) U.S. Cl. 349/114

(57) ABSTRACT

An array substrate includes a transparent substrate, a switching device, an insulation layer, a pixel electrode, a reflective plate and an inner polarization layer. The transparent substrate has a reflective region and a transmissive region. The switching device is formed in the reflective region. The insulation layer is formed on the transparent substrate to cover the switching device. The insulation layer has a contact hole that exposes a portion of a drain electrode of the switching device. The pixel electrode is electrically connected to the drain electrode of the switching device through the contact hole. The reflective plate is electrically connected to the pixel electrode and is disposed at the reflective region. The inner polarization layer covers the reflective plate. Thus the white luminance and the contrast ratio of an LCD apparatus having the above array substrate are enhanced.

### CROSS-REFERENCE TO RELATED APPLICATIONS

This application claims priority to Korean Patent Application No. 2004-104951 filed on Dec. 13, 2004, Korean Patent Application No. 2005-10697 filed on Feb. 4, 2005, and Korean Patent Application No. 2005-10929 filed on Feb. 5, 2005, the contents of which are herein incorporated by reference in their entirety.

### BACKGROUND OF THE INVENTION

1. Field of the Invention

The present invention relates to an array substrate, a method of manufacturing the array substrate and a liquid crystal display apparatus having the array substrate.

2. Description of the Related Art

Generally, a transflective liquid crystal display (LCD) apparatus, having a twisted nematic configuration for its liquid crystal molecules, includes a plurality of pixels. Each of the pixels has a reflective plate and a transmissive window. Two factors to consider when designing a transflective LCD apparatus are the contrast ratio and white color luminance for the LCD apparatus.

Typically, a transflective LCD apparatus has a double cell gap structure. In other words, the cell gap of a transmissive region is double the cell gap of a reflective region of the LCD apparatus.

The transflective LCD apparatus having the double cell gap structure displays an optimized image. However, it is more difficult to manufacture the double cell gap structure as compared to the single gap structure. Even with a transflective LCD apparatus having the single gap structure, white color luminance of a transmissive mode may still be reduced.

To enhance the reflectivity of a transflective LCD apparatus having a single gap structure, the surface area of the reflective plate of the LCD apparatus may be increased. For example, embossing patterns may be formed at the reflective plate for increasing the surface area of the reflective plate, and thereby also enhancing the reflectivity of the LCD apparatus. When the transflective LCD apparatus being used includes a reflective plate having embossing patterns, it is also preferable to dispose an inner polarization layer on the outside of the array substrate of the LCD apparatus.

In addition, each of protrusions of the embossing patterns preferably has, for example, roughly circular shape when viewed on a plane. Moreover, each of the protrusions preferably has a height of about 0.5 μm, and a width of substantially equal to or less than about 15 μm.

Further, to embody the transflective LCD apparatus having the single cell gap structure and a reflective plate having the embossing patterns, a wavegrid polarizer layer having a thickness in a range of about 0.1 μm to about 0.8 μm is formed inside of the liquid crystal cell. However, due to surface tension formed between a surface of the embossing patterns and the inner polarization layer, the arrangement of a wavegrid polarizer of the wavegrid polarizer layer is disrupted to induce light leakage

from the LCD apparatus. In addition, the light leakage further increases when the embossing patterns are deepened.

Therefore, a need exists for a transflective LCD apparatus including a reflective plate having embossing patterns and an inner polarization layer, and which is capable of reducing light leakage from the LCD apparatus.

### SUMMARY OF THE INVENTION

In an exemplary embodiment of the present invention, the array substrate includes a transparent substrate, a switching device, an insulation layer, a pixel electrode, a reflective plate and an inner polarization layer. The transparent substrate has a reflective region and a transmissive region. The switching device is formed in the reflective region. The insulation layer is formed on the transparent substrate to cover the switching device and has a contact hole that exposes a portion of an electrode of the switching device. The pixel electrode is electrically connected to the electrode of the switching device through the contact hole. The reflective plate is electrically connected to the pixel electrode and is disposed at the reflective region. The inner polarization layer covers the reflective plate.

In another exemplary embodiment of the present invention, the array substrate includes a transparent substrate, a switching device, an insulation layer, a reflective plate, a transparent electrode layer and an inner polarization layer. The transparent substrate has a reflective region and a transmissive region. The switching device is formed on the transparent substrate. The switching device includes a gate electrode, a drain electrode and a source electrode. The insulation layer is formed on the transparent substrate to cover the switching device and has a contact hole that exposes a portion of a drain electrode of the switching device. The insulation layer has an upper surface that has substantially the same height throughout the reflective and transmittive regions relative to the transparent substrate. The reflective plate is electrically connected to the drain electrode of the switching device through the contact hole and is disposed at the reflective region. The transparent electrode layer is electrically connected to the reflective plate. The inner polarization layer is formed on the transparent electrode layer of the reflective region to cover the reflective plate.

In still another exemplary embodiment of the present invention, the array substrate includes a substrate, a switching device, a transparent electrode layer, a reflective plate, a planarization layer and an inner polarization layer. The switching device is formed on the substrate. The switching device includes a gate electrode, a source electrode and a drain electrode. The transparent electrode layer is electrically connected to the drain electrode of the switching device. The reflective plate is electrically connected to the drain electrode. The planarization layer is formed on the reflective plate. The inner polarization layer is formed on the planarization layer.

In another exemplary embodiment of the present invention, a method of manufacturing an array substrate is provided, which includes an insulation layer being formed on a substrate having a switching device. The insulation layer has a contact hole that exposes a portion of a drain electrode of the switching device. A transparent electrode layer that is electrically connected to the drain electrode through the contact hole is formed. A reflective plate that is electrically connected to the transparent electrode is formed. An inner polarization layer is formed on the reflective plate.

In another exemplary embodiment of the present invention, a method of manufacturing an array substrate is provided, which includes a switching device having a gate electrode, a source electrode and a drain electrode being formed on a substrate having a reflective region and a transmissive region. An insulation layer having a contact hole that exposes a portion of the drain electrode of the switching device is formed on the substrate. A reflective plate that is electrically connected to the drain electrode through the contact hole is formed at the reflective region. A planarization layer is formed on the insulation layer of the transmissive region and the reflective plate of the reflective region. The planarization layer has a via-hole corresponding to the contact hole. A transparent electrode layer is formed on the planarization layer that is electrically connected to the reflective plate through the via-hole. An inner polarization layer is formed on the transparent electrode layer. A photoresist layer having a first thickness at the transmissive region and a second thickness that is thicker than the first thickness is formed at the reflective region. The photoresist layer is etched such that the photoresist layer of the reflective region is remained and the photoresist layer of the transmissive region is removed. The transparent electrode layer and the inner polarization layer of the transmissive region are removed by using the photoresist layer of the reflective region.

In another exemplary embodiment of the present invention, a liquid crystal display (LCD) apparatus is provided. The LCD apparatus includes a first substrate, a second substrate and a liquid crystal layer. The second substrate is combined with the first substrate. The second substrate includes a reflective plate, a pixel electrode and an inner polarization layer covering the reflective plate. The liquid crystal layer is disposed between the first and second substrates.

In another exemplary embodiment of the present invention, an LCD apparatus is provided. The LCD apparatus has a reflective region and a transmissive region. The LCD apparatus includes a lower substrate, an upper substrate and a liquid crystal layer. The lower substrate includes a substrate, a switching device, an insulation layer, a reflective plate, a planarization layer, a transparent electrode layer and an inner polarization layer. The switching device is formed on the substrate and includes a gate electrode, a source electrode and a drain electrode. The insulation layer is formed on the substrate to cover the switching device. The insulation layer has a contact hole that exposes a portion of the drain electrode of the switching device. The reflective plate is formed on the insulation layer of the reflective region such that the reflective plate is electrically connected to the drain electrode through the contact hole. The planarization layer is formed on the reflective plate of the reflective region, and the insulation layer of the transmissive region. The transparent electrode layer is formed on the planarization layer such that the transparent electrode is electrically connected to the drain electrode. The inner polarization layer is formed on the transparent electrode layer of the reflective region to cover the reflective plate. The upper substrate faces the lower substrate. The liquid crystal layer is disposed between the lower and upper substrate such that the liquid crystal layer. The liquid crystal layer has a uniform cell gap throughout the reflective and transmissive regions.

In still another exemplary embodiment of the present invention, an LCD apparatus is provided. The LCD apparatus includes a lower substrate, an upper substrate and a liquid crystal layer. The lower substrate includes a first transparent substrate, a switching device, a transparent electrode layer, a reflective plate, a planarization layer and an inner polarization layer. The switching device is formed on the first transparent substrate. The switching device has a gate electrode, a source electrode and a drain electrode. The transparent electrode layer is electrically connected to the drain electrode of the switching device. The reflective plate is electrically connected to the drain electrode of the switching device and has flexuous surface. The planarization layer is formed on the reflective plate and has a flat surface. The inner polarization layer is formed on the planarization layer. The upper substrate is combined with the lower substrate. The liquid crystal layer is disposed between the lower and upper substrates.

In still another exemplary embodiment of the present invention, an LCD apparatus is provided. The LCD apparatus includes a first substrate, an upper polarization plate, a second substrate, a lower polarization plate and a laid crystal layer. The upper polarization plate is disposed on an upper surface of the first substrate. The upper polarization plate transmits a light having a first polarization axis. The second substrate is combined with the first substrate including a reflective plate and an inner polarization layer that is disposed on the reflective plate and has a second polarization axis that is substantially perpendicular to the first polarization axis. The lower polarization plate is disposed on a lower surface of the second substrate. The lower polarization plate transmits a light having the second polarization. The liquid crystal layer is disposed between the first and second substrates. The liquid crystal layer rotates a polarization axis of a light, when the light passes through the liquid crystal layer.

### BRIEF DESCRIPTION OF THE DRAWINGS

FIG. 1 is a cross-sectional view illustrating a liquid crystal display (LCD) apparatus having a single cell gap structure according to an exemplary exemplary embodiment of the present invention;

FIGS. 2A and 2B are conceptual views illustrating a light path of the LCD apparatus in FIG. 1;

FIGS. 3A through 3G are cross-sectional views illustrating a method of manufacturing the LCD apparatus in FIG. 1;

FIG. 4 is a cross-sectional view illustrating an LCD apparatus having a signal gap structure according to an exemplary embodiment of the present invention;

FIGS. 5A and 5B are conceptual views illustrating a light path of the LCD apparatus in FIG. 4;

FIG. 6 is a cross-sectional view illustrating an LCD apparatus having a signal gap structure according to an exemplary embodiment of the present invention;

FIGS. 7A through 7G are cross-sectional views illustrating a method of manufacturing the LCD apparatus in FIG. 6;

FIG. 8 is a cross-sectional view illustrating an LCD apparatus having a signal gap structure according to an exemplary embodiment of the present invention;

FIG. 9 is a cross-sectional view illustrating an LCD apparatus according to an exemplary embodiment of the present invention;

FIGS. 10A and 10B are conceptual views illustrating a light path of the LCD apparatus in FIG. 9;

FIGS. 11A through 11J are cross-sectional views illustrating a method of manufacturing the LCD apparatus in FIG. 9;

FIG. 12 is a cross-sectional view illustrating an LCD apparatus according to an exemplary embodiment of the present invention;

FIGS. 13A and 13B are conceptual views illustrating a light path of the LCD apparatus in FIG. 12;

FIG. 14 is a cross-sectional view illustrating an LCD apparatus according to an exemplary embodiment of the present invention;

FIGS. 15A and 15B are conceptual views illustrating a light path of the LCD apparatus in FIG. 14;

FIG. 16 is a cross-sectional view illustrating an LCD apparatus according to an exemplary embodiment of the present invention; and

FIGS. 17A and 17B are conceptual views illustrating a light path of the LCD apparatus in FIG. 16.

### DESCRIPTION OF THE EXEMPLARY EMBODIMENTS

It should be understood that the exemplary embodiments of the present invention described below may be varied modified in many different ways without departing from the inventive principles disclosed herein, and the scope of the present invention is therefore not limited to these particular flowing embodiments.

Hereinafter, the embodiments of the present invention will be described in detail with reference to the accompanied drawings. It is noted that various changes, substitutions and alterations can be made herein without departing from the spirit and scope of the invention as defined by embodiments that will be described below. The embodiments are only examples for showing the sprit of the present invention to a person skilled in the art. In the figures, a thickness of layers is exaggerated for clarity. The term “disposed on” means “disposed over”. In other words, something may be disposed therebetween. The term “disposed directly on” means that nothing is disposed therebetween.

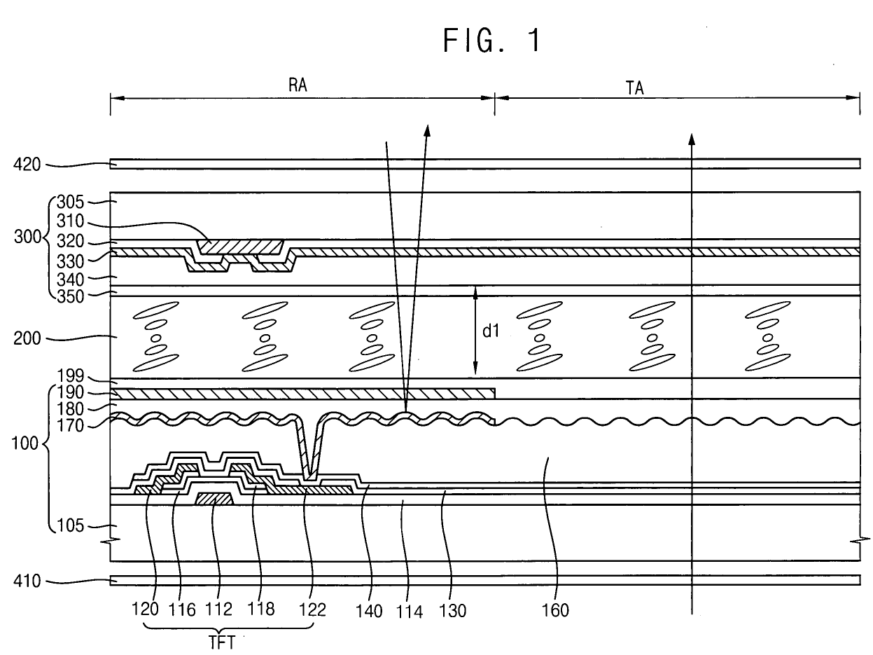

FIG. 1 is a cross-sectional view illustrating a liquid crystal display (LCD) apparatus having a single cell gap structure according to an exemplary embodiment of the present invention.

Referring to FIG. 1, the liquid crystal display (LCD) panel includes an array substrate 100, a liquid crystal layer 200, a color filter substrate 300, a first polarization plate 410 and a second polarization plate 420. The array substrate 100 and the color filter substrate 300 are combined with each other. The liquid crystal layer 200 is disposed between the array substrate 100 and the color filter substrate 300. The first polarization plate 410 is disposed on a lower face of the array substrate 100, and the second polarization plate 420 is disposed on an upper face of the color filter substrate 300. The first and second polarization plates 410 and 420 have different polarization axis from each other. For example, a polarization axis of the first polarization plate 410 is substantially perpendicular to a polarization axis of the second polarization plate 420.

The array substrate 100 includes a first transparent substrate 105, a gate electrode 112 and a gate insulation layer 114. The gate electrode 112 is formed on the first transparent substrate 105. The gate electrode 112 is protruded from a gate line. The gate insulation layer 114 includes, for example silicon nitride (SiNx). The gate insulation layer 114 is formed on the first transparent substrate 105 having the gate electrode 112 to cover the gate electrode 112. The gate line and the gate electrode 112 include but are not limited to a metal or a metal alloy such as aluminum (Al), aluminum alloy, silver (Ag), silver alloy, copper (Cu), copper alloy, molybdenum (Mo), molybdenum alloy, chromium (Cr), tantalum (Ta), titanium (Ti), etc.

The array substrate 100 further includes a semiconductor layer 116, an ohmic contact layer 118, a source electrode 120 and a drain electrode 122. The semiconductor layer 116 includes, for example amorphous silicon (a-Si), and the ohmic contact layer 118 includes, for example n-doped amorphous silicon (a-Si). The source electrode 120 covers a first portion of the ohmic contact layer 118, and the drain electrode 122 covers a second portion o the ohmic contact layer 118. The source and drain electrodes 120 and 122 are spaced apart from each other. The gate electrode 112, the semiconductor layer 116, the ohmic contact layer 118, the source electrode 120 and the drain electrode 122 form a thin film transistor (TFT). The source and drain electrodes 120 and 122 may include but are not limited to a metal or a metal alloy such as aluminum (Al), aluminum alloy, silver (Ag), silver alloy, copper (Cu), copper alloy, molybdenum (Mo), molybdenum alloy, chromium (Cr), tantalum (Ta), titanium (Ti), etc.

The gate, source and drain electrodes 112, 120 and 122 have, for example a single layered structure. Alternatively, one of the gate, source and drain electrodes 112, 120 and 122 may have a multi-layered structure. When the gate, source and drain electrodes 112, 120 and 122 have a single layered structure, the gate, source and drain electrodes 112, 120 and 122 may include but are not limited to a metal or a metal alloy such as aluminum (Al), aluminum neodymium (AlNd), copper (Cu), etc. When the gate, source and drain electrodes 112, 120 and 122 have, for example a double layered structure including a lower layer and an upper layer, the lower layer include but are not limited to a metal such as chromium (Cr), molybdenum (Mo), molybdenum alloy, etc., and the upper layer includes a metal or a metal alloy such as aluminum, aluminum alloy, etc.

The array substrate 100 further includes a passivation layer 130 and a pixel electrode layer 140. The passivation layer 130 includes a contact hole that exposes a portion of the drain electrode 122. The pixel electrode layer 140 is formed on the passivation layer 130. The pixel electrode layer 140 is electrically connected to the drain electrode 122 through the contact hole. The passivation layer 130 protects the semiconductor layer 116 and the ohmic contact layer 118 disposed between the source and drain electrodes 120 and 122. The pixel electrode layer 140 is disposed at both of a reflective region RA and a transmissive region TA.

The array substrate 100 further includes an organic insulation layer 160, a reflective plate 170, a planarization layer 180, an inner polarization layer 190 and a first alignment layer 199. The organic insulation layer 160 covers the pixel electrode layer 140. The organic insulation layer 160 includes a via-hole that exposes a portion of the pixel electrode layer 140. The via-hole is disposed over the contact hole. The organic insulation layer 160 has embossing patterns. The embossing patterns are formed on an upper surface of the organic insulation layer 160. The reflective plate 170 is formed at the reflective region RA. The reflective plate 170 is electrically connected to the pixel electrode through the via-hole. The planarization layer 180 is formed on the reflective plate 170. The inner polarization layer 190 is formed on the planarization layer 180. The first alignment layer 199 is formed on the inner polarization layer 190. The inner polarization layer 190 and the first polarization plate 410 have substantially parallel polarization axis.

Preferably, the planarization layer 180 has a relatively thinner thickness as long as the planarization layer 180 levels the embossing patterns. For example, when the embossing patterns have a height of about 0.5 μm, the planarization layer 180 has a thickness of about 0.5 μm.

The color filter substrate 300 includes a second transparent substrate 305, a light blocking layer 310, a color filter layer 320, an over coating layer 330, a common electrode layer 340 and a second alignment layer 350. The light blocking layer 310 is formed on the second transparent substrate 305. The light blocking layer 310 includes a plurality of openings arranged in a matrix shape. Each of the openings defines a pixel. The color filter layer 320 is formed on the second transparent substrate 305 exposed through the openings of the light blocking layer 310. The over coating layer 330 is formed on the color filter layer 320. The common electrode layer 330 is formed on the over coating layer 330. The second alignment layer 350 is formed on the common electrode layer 330. The color filter substrate 300 is combined with the array substrate 100 such that the liquid crystal layer 200 is disposed between the color filter substrate 300 and the array substrate 100.

Thin crystal film (TCF®) of Optiva Inc. in U.S.A may be employed as the inner polarization layer 190. The thin crystal film includes dyestuff of a chromogen base.

Optical characteristics of the thin crystal film are described in the following Table 1.

TABLE 1

| Optical characteristics of samples | | | | | |
|---|---|---|---|---|---|
| Transparency | H90 | H0 | Efficiency | Contrast | TCF thickness |
| (%) | (%) | (%) | (%) | ratio | (μm) |
| 44.95 | 5.26 | 35.15 | 86.00 | 6.68 | 0.3 |
| 44.53 | 5.08 | 34.57 | 86.25 | 6.81 | 0.3 |
| 43.89 | 4.93 | 33.59 | 86.25 | 6.81 | 0.3 |
| 43.73 | 4.55 | 33.70 | 87.29 | 7.40 | 0.3 |
| 33.72 | 0.18 | 33.56 | 99.20 | 124.01 | 0.4 |
| 34.22 | 0.11 | 23.31 | 99.54 | 215.46 | 0.6 |
| 34.20 | 0.12 | 23.23 | 99.50 | 201.30 | 0.6 |
| 33.65 | 0.10 | 22.54 | 99.55 | 219.46 | 0.6 |

In Table 1, ‘H0’ represents a ‘parallel transmittance’ that corresponds to a transmittance when the polarizing axes of the first and second polarizing plates 410 and 420 are substantially parallel with each other, and ‘H90’ represents a ‘perpendicular transmittance’ that corresponds to a transmittance when the polarizing axes of the first and second polarizing plates 410 and 420 are substantially perpendicular to each other. Hereinafter, both of the parallel transmittance and the perpendicular transmittance are referred to as ‘polarization transmittance’.

Referring to Table 1, the polarization transmittance, the contrast ratio is changed when the thickness of thin crystal film is changed. In detail, when the thickness of thin crystal film increases, the polarization transmittance decreases and the contrast ratio increases.

The thin crystal film according to the exemplary embodiments of the present invention having above described optical characteristics may be employed by a transflective LCD apparatus for enhancing the display quality of the transflective LCD apparatus. A transflective LCD apparatus includes both the reflective plate and transmissive window. It is noted that the polarization transmittance is a more important factor than the contrast ratio in a reflective mode. However, the contrast ratio is a more import factor than the polarization transmittance in a transmissive mode. By using a thin crystal film according to exemplary embodiments of the invention, a transflective LCD apparatus having a relatively high transmittance at the reflective region RA and a relatively high contrast ratio at the transmissive region is provided, thereby enhancing the display quality of the LCD apparatus.

The thin crystal film corresponds to a polymer resin that is a gel type and has a viscosity of about 300 psi. Thus, the thin crystal film may be formed, for example by slot die coating method.

Hereinafter, a transmissive mode operation and a reflective mode operation of the transflective LCD apparatus according to the present exemplary embodiment will be explained. For example, the transflective LCD apparatus that will be explained displays white color when no electric fields are applied to the liquid crystal layer 200. In other words, the transflective LCD apparatus corresponds to a normally white mode. The transflective LCD apparatus includes a first polarization plate 410 that has a first polarization axis, an inner polarization layer 190 that has a polarization axis that is substantially parallel with the first polarization axis, and a second polarization plate 420 having a second polarization axis that is substantially perpendicular to the first polarization axis.

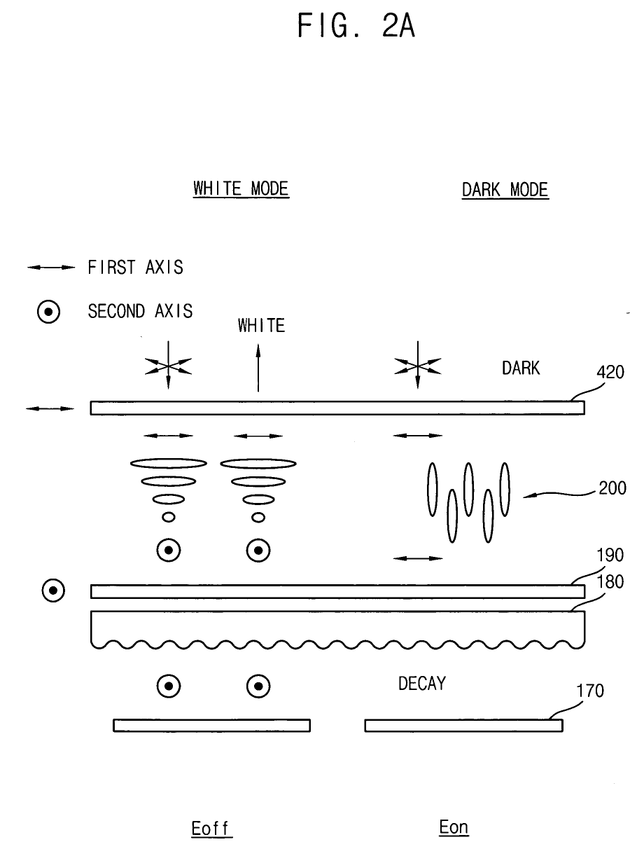

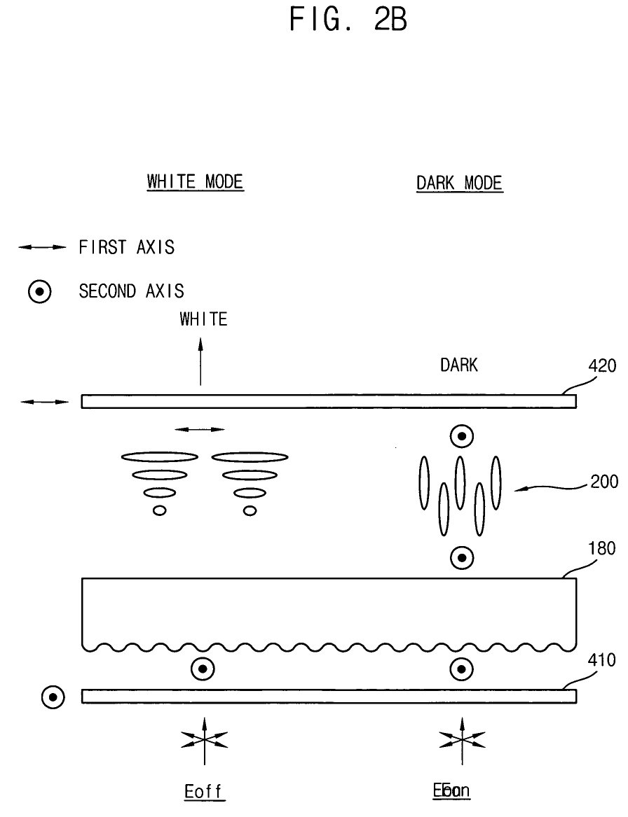

FIGS. 2A and 2B are conceptual views illustrating a light path of the LCD apparatus in FIG. 1. Hereinafter, a ‘first axis’ is defined as an axis that is disposed on a paper of drawings, and a ‘second axis’ is defined as an axis that is substantially parallel with a normal line of the paper.

Reflective Mode Operation

FIG. 2A corresponds to the reflective mode of the transflective LCD apparatus in FIG. 1.

Referring to FIG. 2A, when external light advances toward the second polarization plate 420, a portion of that light oscillates along the first axis and passes through the second polarization plate 420, and the remaining portion of the light is blocked by the second polarization plate 420. If no electric fields are applied to the liquid crystal layer 200 (Eoff), a portion of the light passes through the liquid crystal layer 200 and is rotated to oscillate along the second axis. The portion of the light which oscillates along the second axis, passes through the inner polarization layer 190 because the inner polarization layer 190 has a polarization axis that is substantially perpendicular to a polarization axis of the second polarization plate 420, and thus this portion of the light is reflected by the reflective plate 170 and passes through the inner polarization layer 190. The portion of the light that exits from the inner polarization layer 190 enters the liquid crystal layer 200. When the portion of the light exits from the liquid crystal layer 200, this portion of the light is rotated by the liquid crystal layer 200 to pass through the second polarization plate 420, thereby resulting in white color being displayed.

When electric fields are applied to the liquid crystal layer 200 (Eon), the arrangement of liquid crystal molecules in the liquid crystal layer 200 is changed, so that the portion of light that passes through the second polarization plate 420 passes through the liquid crystal layer 200 without being rotated. As a result, the portion of light that passes through the liquid crystal layer 200 without being rotated is blocked by the inner polarization layer 190, so that the reflective plate 170 does not reflect light, thereby resulting in a black color being displayed.

Transmissive Mode Operation

FIG. 2B corresponds to the transmissive mode of the transfiective LCD apparatus in FIG. 1.

Referring to FIG. 2B, light generated from a backlight assembly advances toward the first polarization plate 410. A portion of that light oscillates along the second axis and passes through the first polarization plate 410, and the remaining portion of the light is blocked by the first polarization plate 410. If no electric fields are applied to the liquid crystal layer 200 (Eoff), a portion of the light passes through the liquid crystal layer 200 and is rotated to oscillate along the first axis. The portion of the light that oscillates along the first axis passes through the second polarization plate 420, because the second polarization plate 420 has a polarization axis that is substantially perpendicular to a polarization axis of the first polarization plate 410, thereby also resulting in white color being displayed.

When electric fields are applied to the liquid crystal layer 200 (Eon), the arrangement of liquid crystal molecules in the liquid crystal layer 200 is changed, so that the portion of light that passes through the first polarization plate 410 passes through the liquid crystal layer 200 without being rotated. As a result, the portion of light that passes through the liquid crystal layer 200 without being rotated is blocked by the second polarization plate 420, so only black color is displayed.

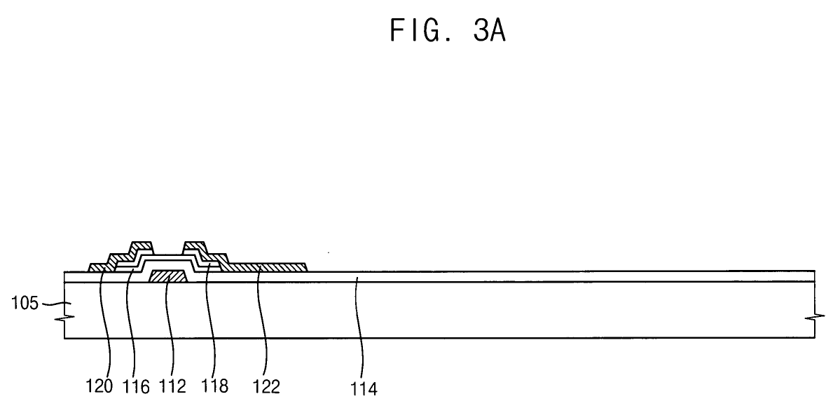

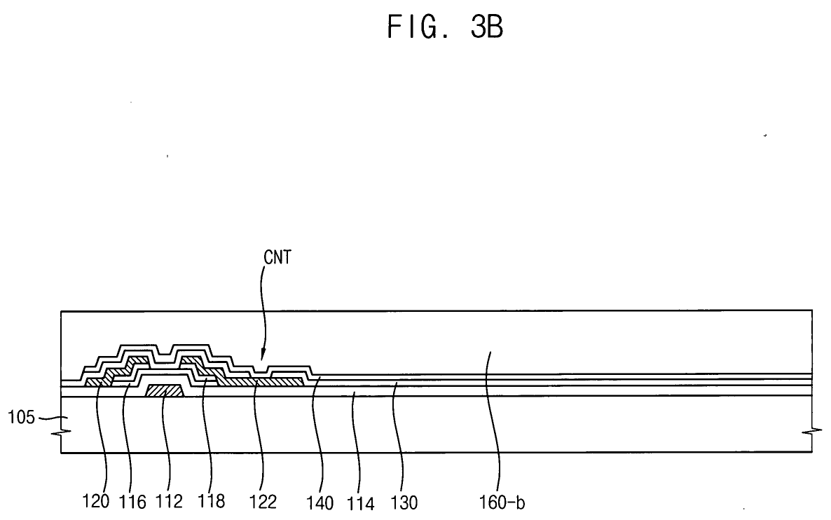

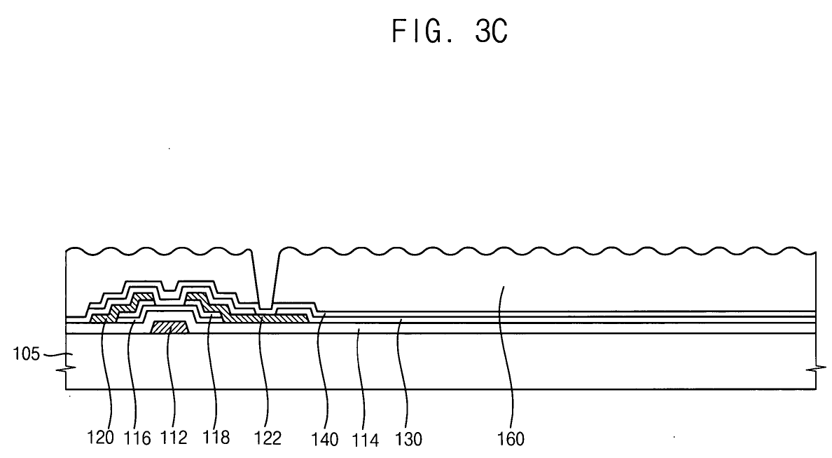

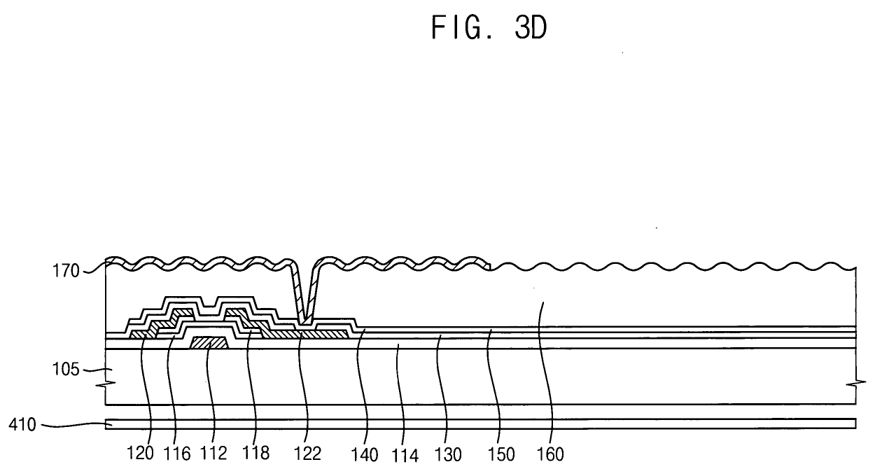

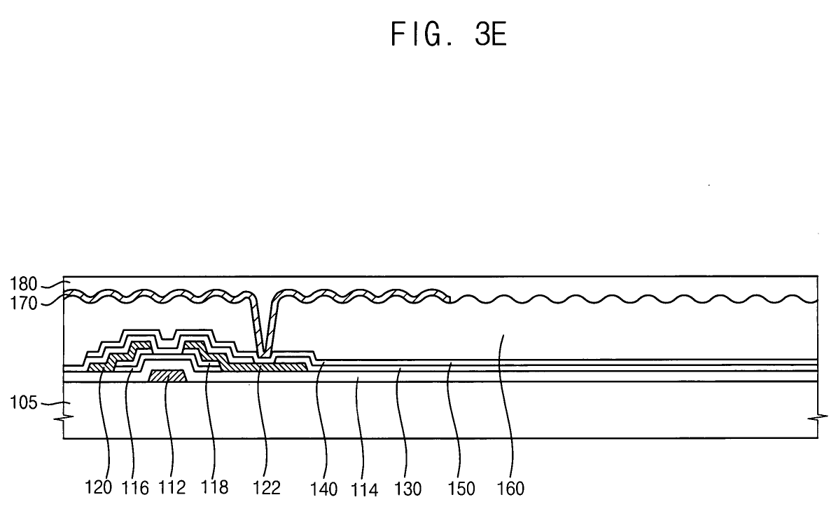

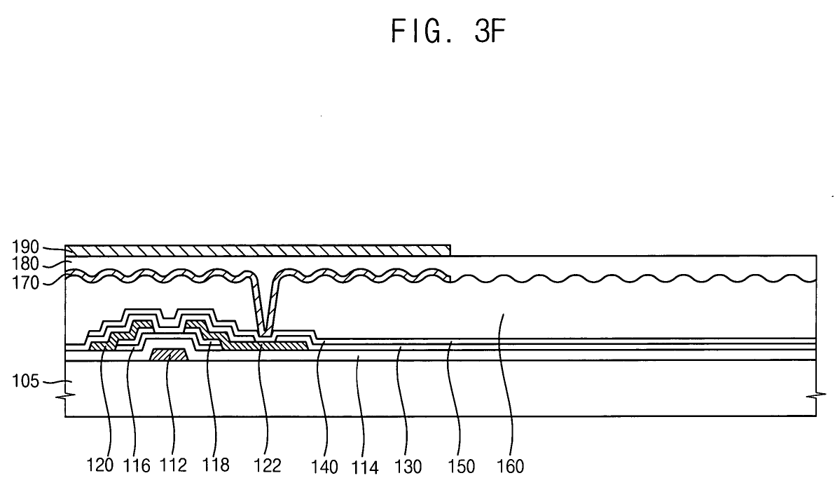

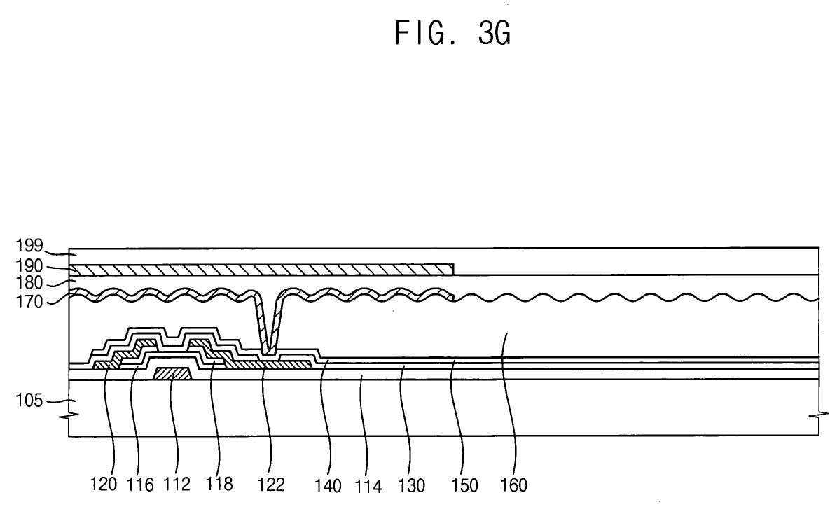

FIGS. 3A through 3G are cross-sectional views illustrating a method of manufacturing the LCD apparatus in FIG. 1.

Referring to FIG. 3A, a metal layer including but not limited to a metal such as tantalum (Ta), titanium (Ti), molybdenum (Mo), aluminum (Al), chromium (Cr), copper (Cu), tungsten (W), etc. is formed on the first transparent substrate 105 including glass, ceramic, etc.

The metal layer is patterned to form a plurality of gate lines and a gate electrode 112 protruded from the gate line.

The gate insulation layer 114 including, for example silicon nitride is formed on the first transparent substrate 105 having the gate lines and the gate electrode 112 to cover the gate lines and the gate electrode 112. The gate insulation layer 114 may be formed on all portions of an upper surface of the first transparent substrate 105. Alternatively, the gate insulation layer 114 may be formed on only portions of the upper surface of the first transparent substrate 105 such that the gate insulation layer 114 covers the gate line and the gate electrode 112.

An amorphous silicon (a-Si) layer is formed on the gate insulation layer 114 and n+ amorphous silicon (n+ a-Si) layer is formed on the amorphous silicon layer. Further, the amorphous silicon layer and the n+ amorphous silicon layer are patterned to form the semiconductor layer 116 and the ohmic contact layer 118 of the thin film transistor.

A metal layer including but not limited to a metal such as tantalum (Ta), titanium (Ti), molybdenum (Mo), aluminum (Al), chromium (Cr), copper (Cu), tungsten (W), etc. is formed on the first transparent substrate 105 having the semiconductor layer 116 and the ohmic contact layer 118. The metal layer is patterned to form the plurality of source lines, the source electrode 120 which protrudes from the source lines, and the drain electrode 122 which is spaced apart from the source electrode 120.

Referring to FIG. 3B, the passivation layer 130 is formed on the first transparent substrate 105 having the plurality of source lines, the source electrode 120 and the drain electrode 122, by way of, e.g., a spin coating method. Other methods known in the art for forming the passivation layer 130 may also be used. A portion of the passivation layer 130 is removed to form the contact hole CNT that exposes a portion of the drain electrode 122. Then, the pixel electrode layer 140 is formed on the passivation layer 130. The pixel electrode layer 140 is electrically connected to the drain electrode 122 through the contact hole CNT. The pixel electrode layer 140 includes an optically transparent and electrically conductive material such as indium tin oxide (ITO), indium zinc oxide (IZO), zinc oxide (ZO), etc. The pixel electrode layer 140 may be formed on a portion of an upper surface of the passivation layer 130, which corresponds to pixel region. Alternatively, the pixel electrode layer 140 may be formed on all portions of the upper surface of the passivation layer 130, and the pixel electrode layer 140 may be patterned. A primitive organic insulation layer 160-b is formed on the pixel electrode layer 140.

Referring to FIG. 3C, embossing patterns and via-hole that exposes the pixel electrode layer 140 are formed on an upper surface of the primitive organic insulation layer 160-b to form the organic insulation layer 160. For example, a photo mask having patterns that correspond to the embossing patterns is disposed over the primitive organic insulation layer 160-b, and the primitive organic insulation layer 160-b is exposed and developed to form the organic insulation layer having the embossing patterns and the via-hole.

Referring to FIG. 3D, a metal layer including but not limited to a metal or metal alloy such as aluminum (Al), silver (Ag), aluminum neodymium (AlNd), etc. is formed on the organic insulation layer 160 having the embossing patterns, and the metal layer is patterned to form the reflective plate 170. The reflective plate 170 has a relatively thin thickness, so that the reflective plate 170 has the same or at least substantially the same surface shape as that of the organic insulation layer 160. In other words, the reflective plate 170 also includes embossing patterns. As a result, the reflective plate 170 resembles a plurality of convex mirrors and a plurality of concave mirrors.

Referring to FIG. 3E, a planarization layer 180 that is optically transparent is formed on the organic insulation layer 160 having the reflective plate 170. The planarization layer 180 levels the surface of the reflective plate 170 corresponding to the reflective region and the insulation layer 160 corresponding to the transmissive region. Portions of the planarization layer 180, which correspond to a data pad that corresponds to an end portion of the data line, and a gate pad that corresponds to an end portion of the gate line, are each preferably removed to expose the data pad and the gate pad.

Referring to FIG. 3F, the inner polarization layer 190 is formed on the planarization layer 180. By way of example, a disc type liquid crystal layer is formed on the planarization layer 180, through a slit coating method, wherein a shear stress is applied along a desired polarization axis. The disc type liquid crystal layer is pre-cured, and a portion of the disc type liquid crystal layer, which corresponds to the transmissive region is removed through a wet-etching process or dry etching process. As a result, the disc type liquid crystal layer is disposed only at the reflective region. The disc type liquid crystal layer corresponds to the inner polarization layer 190.

Referring to FIG. 3G, the first alignment layer 199 is formed on the planarization layer 180 and the inner polarization layer 190 through a polyimide printing method. The first alignment layer 199 undergoes a rubbing process. When rubbing is non-uniform, the display quality of the LCD apparatus is deteriorated. Macroscopic characteristics of the liquid crystal layer is dependant on an arrangement of the liquid crystal molecules of the liquid crystal layer, and the first alignment layer 199 applies a boundary condition to the liquid crystal molecules that makes contact with the first alignment layer 199. When an LCD apparatus employs twisted nematic (TN) liquid crystal mode, a polyimide layer is preferably employed as the first alignment layer 199. Polyimide acid or polyimide solution of about 4% by weight to about 8% by weight may be used for the polyimide solution.

The first alignment layer 199 has a thickness of about 500 angstroms to about 1000 angstroms. When a thickness variation of the first alignment layer 199 exceeds 100 angstroms, the display quality of the LCD apparatus is reduced. Therefore, the thickness variation of the first alignment layer 199 should be adjusted to be less than about 100 angstroms.

To adjust the thickness variation of the first alignment layer 199, a pre-curing process is performed. In situations where the drying speed of the solvent is high, the polyimide solution is first hardened before the polyimide solution is uniformly diffused. When the pre-curing process is completed, a hard-curing process is then performed.

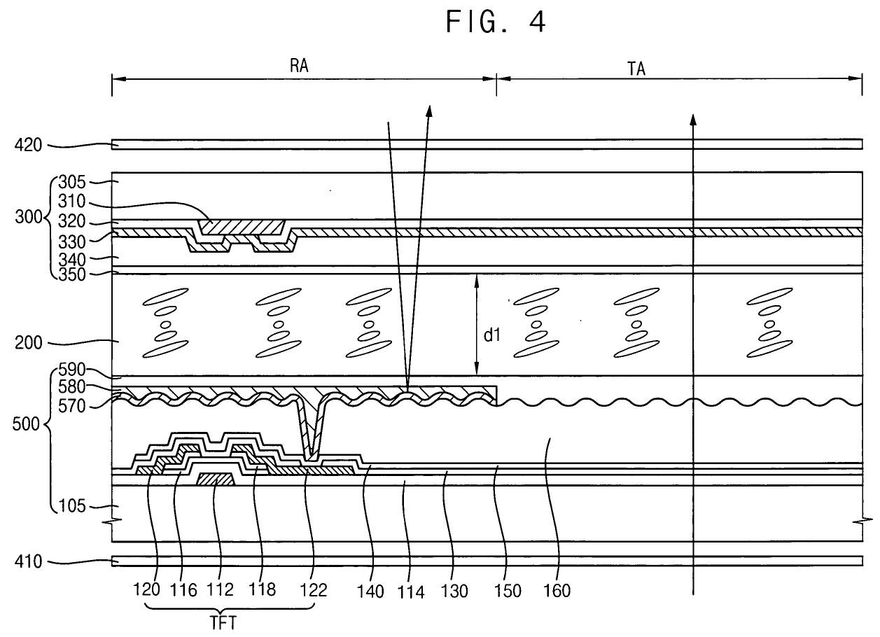

FIG. 4 is a cross-sectional view illustrating an LCD apparatus having a signal gap structure according to an exemplary embodiment of the present invention.

Referring to FIG. 4, the liquid crystal display (LCD) panel includes an array substrate 500, a liquid crystal layer 200, a color filter substrate 300, a first polarization plate 410 and a second polarization plate 420. The array substrate 500 and the color filter substrate 300 are combined with each other. The liquid crystal layer 200 is disposed between the array substrate 500 and the color filter substrate 300. The first polarization plate 410 is disposed on a lower face of the array substrate 500, and the second polarization plate 420 is disposed on an upper face of the color filter substrate 200. The first and second polarization plates 410 and 420 have different polarization axis from each other. For example, a polarization axis of the first polarization plate 410 is substantially perpendicular to a polarization axis of the second polarization plate 420. The LCD panel of the present exemplary embodiment is same as the previous exemplary embodiment depicted in FIGS. 1-3G except for the array substrate 500. Thus, the same reference numerals will be used to refer to the same or like parts as those described in the previous exemplary embodiment of FIGS. 1-3G and any further explanation concerning the above elements will be omitted.

The array substrate 500 includes an organic insulation layer 160, a reflective plate 570, an inner polarization layer 580 and a first alignment layer 590. The organic insulation layer 160 covers the pixel electrode layer 140. A plurality of embossing patterns are formed on an upper surface of the organic insulation layer 160. The reflective plate 570 is formed on the organic insulation layer 160. The reflective plate 570 is disposed at the reflective region RA. The inner polarization layer 580 is formed on the reflective plate 570. The first alignment layer 590 is formed on the reflective plate 570 and the organic insulation layer 160. A polarization axis of the inner polarization layer 580 is substantially parallel with a polarization layer of the first polarization plate 410.

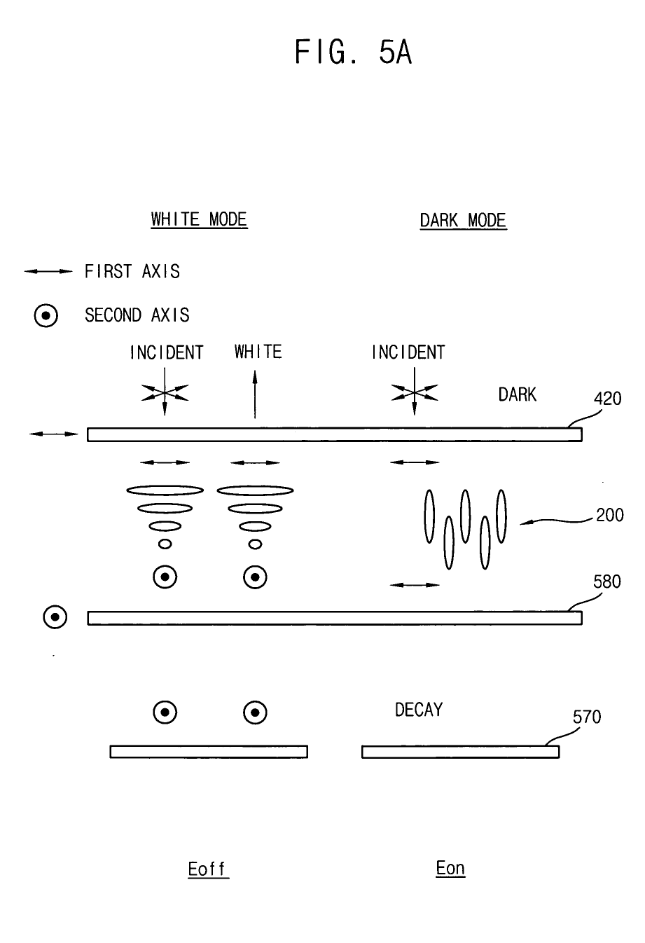

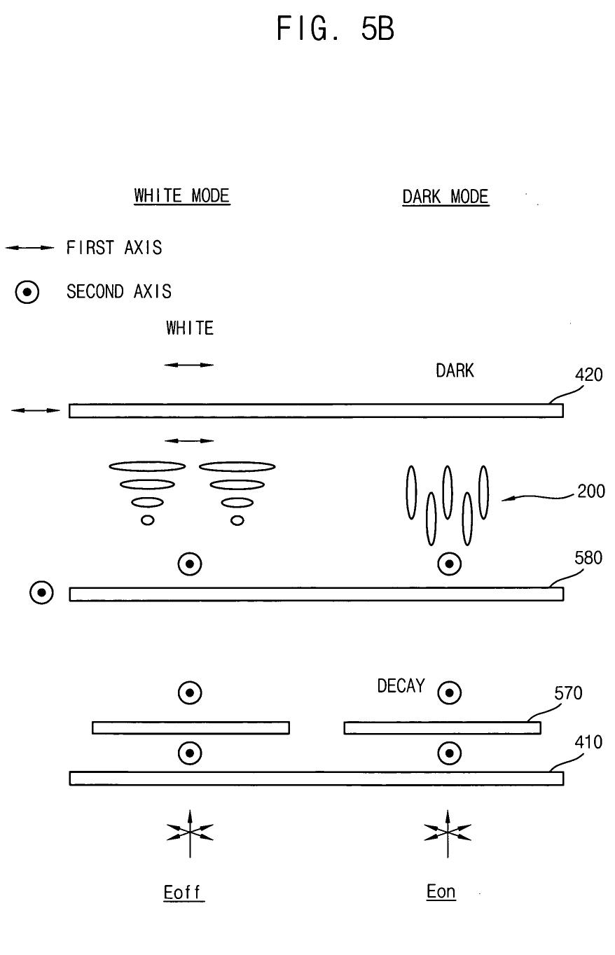

FIGS. 5A and 5B are conceptual views illustrating a light path of the LCD apparatus in FIG. 4. Hereinafter, a ‘first axis’ is defined as an axis that is disposed on a paper of drawings, and a ‘second axis’ is defined as an axis that is substantially parallel with a normal line of the paper.

Reflective Mode Operation

FIG. 5A corresponds to the reflective mode of the transflective LCD apparatus in FIG. 4.

Referring to FIG. 5A, when external light advances toward the second polarization plate 420, a portion of that light oscillates along the first axis and passes through the second polarization plate 420, and the remaining portion of the light is blocked by the second polarization plate 420. If no electric fields are applied to the liquid crystal layer 200 (Eoff), a portion of the light passes through the liquid crystal layer 200 and is rotated to oscillate along the second axis. The portion of light that oscillates along the second axis passes through the inner polarization layer 580, because the inner polarization layer 580 has a polarization axis that is substantially perpendicular to a polarization axis of the second polarization plate 420, so that the portion of the light is reflected by the reflective plate 170 and passes through the inner polarization layer 580. The portion of the light that exits from the inner polarization layer 580 enters the liquid crystal layer 200. When the portion of the light that exits from the liquid crystal layer 200, this portion of the light is rotated by the liquid crystal layer 200 to pass through the second polarization plate 420, thereby resulting in white color being displayed.

When electric fields are applied to the liquid crystal layer 200 (Eon), the arrangement of liquid crystal molecules in the liquid crystal layer 200 is changed, so that the portion of light that passes through the second polarization plate 420 passes through the liquid crystal layer 200 without being rotated. Thus, the portion of light that passes through the liquid crystal layer 200 without being rotated is blocked by the inner polarization layer 580, so that the reflective plate 570 does not reflect light, thereby resulting in black color being displayed.

Transmissive Mode Operation

FIG. 5B corresponds to the transmissive mode of the transfiective LCD apparatus in FIG. 4.

Referring to FIG. 5B, light generated from a backlight assembly advances toward the first polarization plate 410. A portion of that light oscillates along the second axis and passes through the first polarization plate 410. The remaining portion of the light is blocked by the first polarization plate 410. If no electric fields are applied to the liquid crystal layer 200 (Eoff), a portion of the light passes through the liquid crystal layer 200 and is rotated to oscillate along the first axis. The portion of the light that oscillates along the first axis passes through the second polarization plate 420, because the second polarization plate 420 has a polarization axis that is substantially perpendicular to a polarization axis of the first polarization plate 410, thereby also causing white color to be displayed.

When electric fields are applied to the liquid crystal layer 200 (Eon), the arrangement of liquid crystal molecules in the liquid crystal layer 200 is changed, so that the portion of light that passes through the first polarization plate 410 passes through the liquid crystal layer 200 without being rotated. As a result, the portion of light that passes through the liquid crystal layer 200 without being rotated is blocked by the second polarization plate 420, and thus black color is displayed.

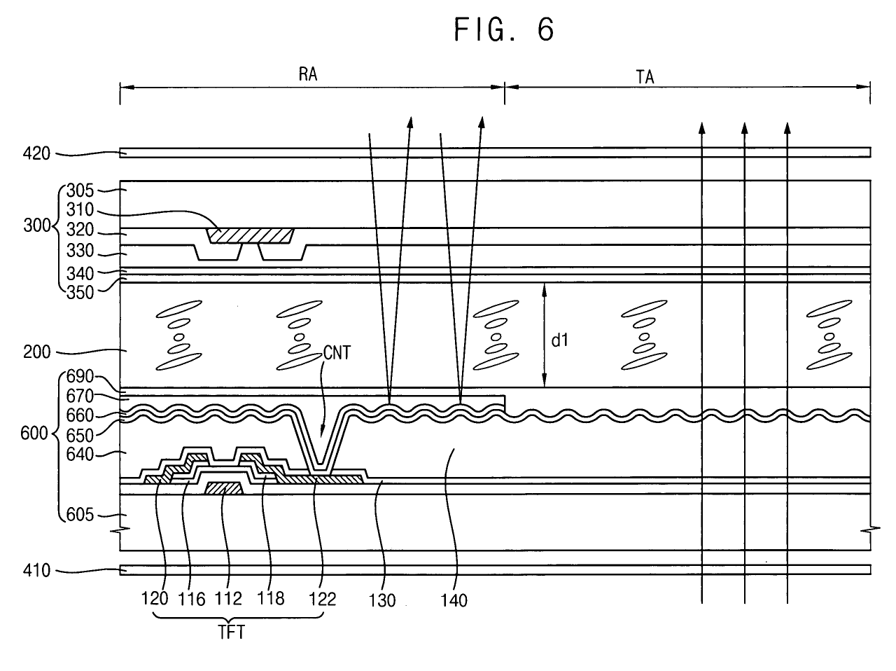

FIG. 6 is a cross-sectional view illustrating an LCD apparatus having a signal gap structure according to an exemplary embodiment of the present invention.

Referring to FIG. 6, a liquid crystal display (LCD) panel includes an array substrate 600, a liquid crystal layer 200, a color filter substrate 300, a first polarization plate 410 and a second polarization plate 420. The array substrate 600 and the color filter substrate 300 are combined with each other. The liquid crystal layer 200 is disposed between the array substrate 600 and the color filter substrate 300. The first polarization plate 410 is disposed on a lower face of the array substrate 600, and the second polarization plate 420 is disposed on an upper face of the color filter substrate 200. The first and second polarization plates 410 and 420 have a different polarization axis from each other. For example, a polarization axis of the first polarization plate 410 is substantially perpendicular to a polarization axis of the second polarization plate 420. The LCD panel of the present embodiment is same as the previous exemplary embodiment depicted in FIGS. 1-3G except for the array substrate 500. Thus, the same reference numerals will be used to refer to the same or like parts as those described in the exemplary embodiment depicted in FIGS. 1-3G and any further explanation concerning the above elements will be omitted.

The array substrate 600 includes a passivation layer 130, an organic insulation layer 640, a pixel electrode layer 650, a reflective plate 660, an inner polarization layer 670 and a first alignment layer 680.

The passivation layer 130 covers the thin film transistor TFT. The passivation layer 130 includes a contact hole that exposes a portion of the drain electrode 122 of the thin film transistor TFT. The passivation layer 130 protects the semiconductor layer 116 and the ohmic contact layer 118 disposed between the source and drain electrodes 120 and 122.

The organic insulation layer 640 is formed on the passivation layer 130. The organic insulation layer 640 has embossing patterns. The embossing patterns are formed on an upper surface of the organic insulation layer 640. The organic insulation layer 640 includes a connection hole CNT that exposes a portion of the drain electrode 122 of the thin film transistor TFT.

The pixel electrode layer 650 is formed on the organic insulation layer 640. The pixel electrode layer 650 is electrically connected to the drain electrode 122 of the thin film transistor TFT through the connection hole CNT. The pixel electrode layer 650 includes an optically transparent and electrically conductive material such as indium tin oxide (ITO), indium zinc oxide (IZO), zinc oxide (ZO), etc.

The reflective plate 660 is formed on the pixel electrode layer 650. The reflective plate 660 is disposed at the reflective region RA. The inner polarization layer 670 is formed on the reflective plate 660. The first alignment layer 680 is formed on the inner polarization layer 670 and the pixel electrode layer 650. A polarization axis of the inner polarization layer 670 is substantially parallel with a polarization layer of the first polarization plate 410.

The color filter substrate 300 includes a second transparent substrate 305, a light blocking layer 310, a color filter layer 320, an over coating layer 330, a common electrode layer 340 and a second alignment layer 350. The light blocking layer 310 is formed on the second transparent substrate 305. The light blocking layer 310 includes a plurality of openings arranged in a matrix shape. Each of the openings defines a pixel. The color filter layer 320 is formed on the second transparent substrate 305 exposed through the openings of the light blocking layer 310. The over coating layer 330 is formed on the color filter layer 320. The common electrode layer 330 is formed on the over coating layer 330. The second alignment layer 350 is formed on the common electrode layer 330. The color filter substrate 300 is combined with the array substrate 100 such that the liquid crystal layer 200 is disposed between the color filter substrate 300 and the array substrate 100.

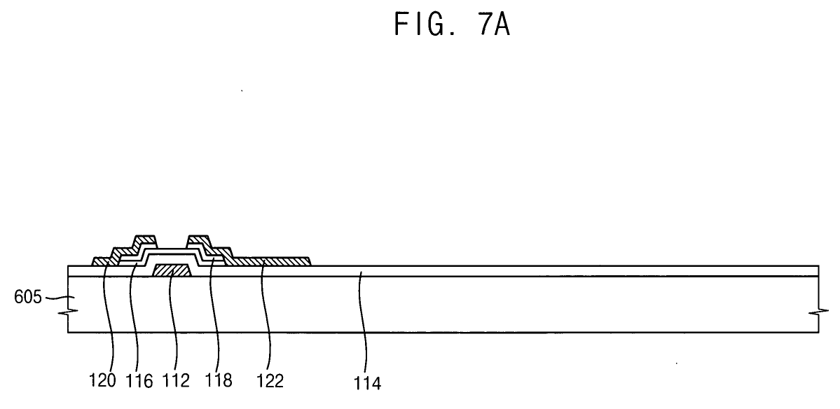

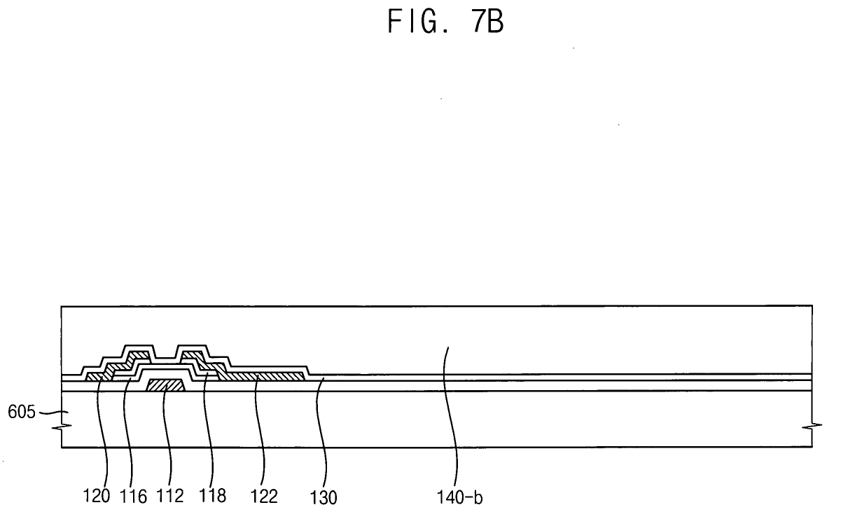

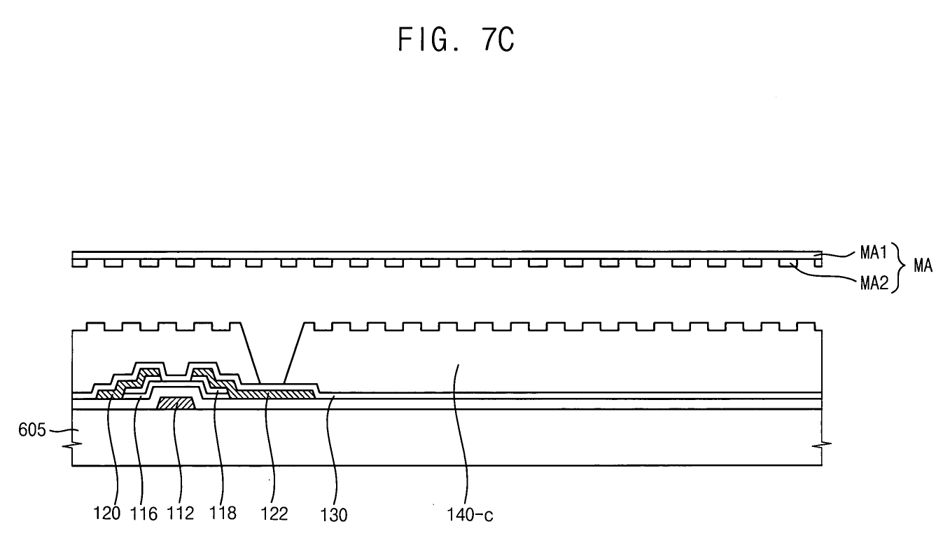

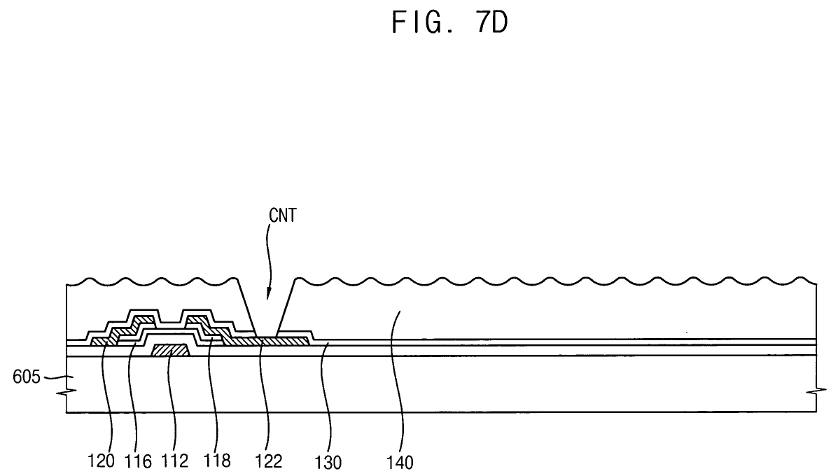

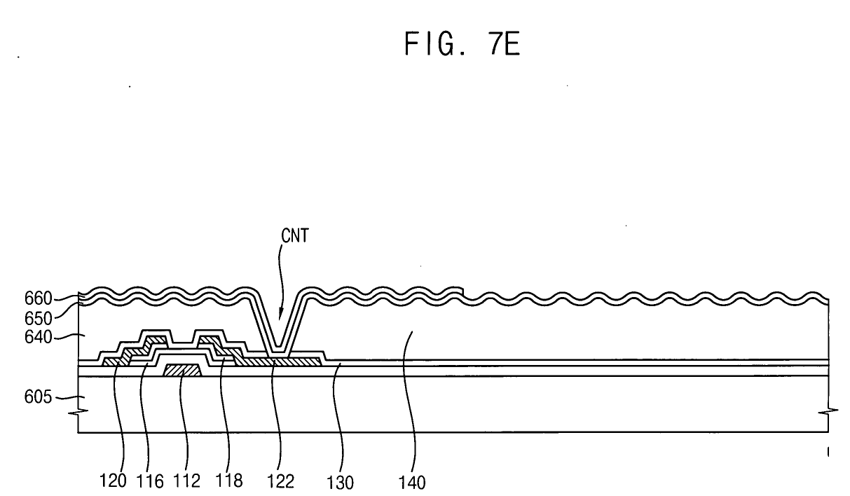

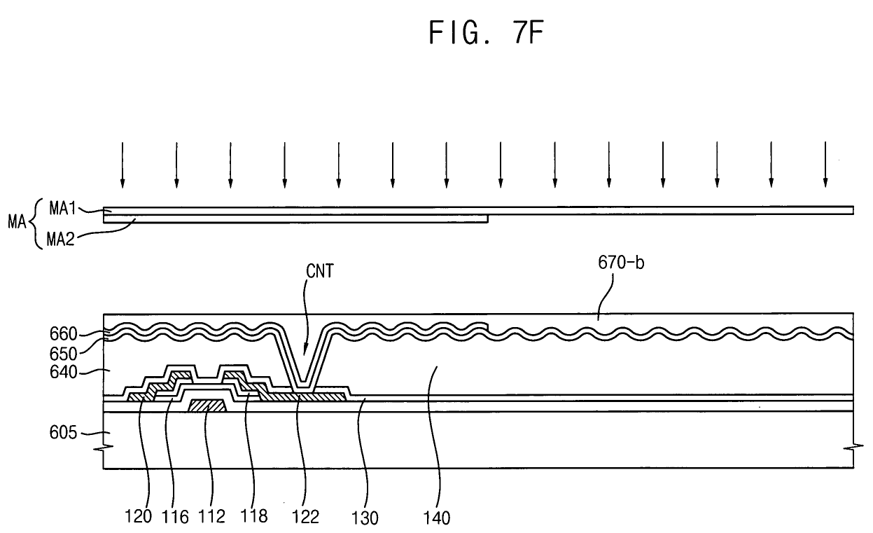

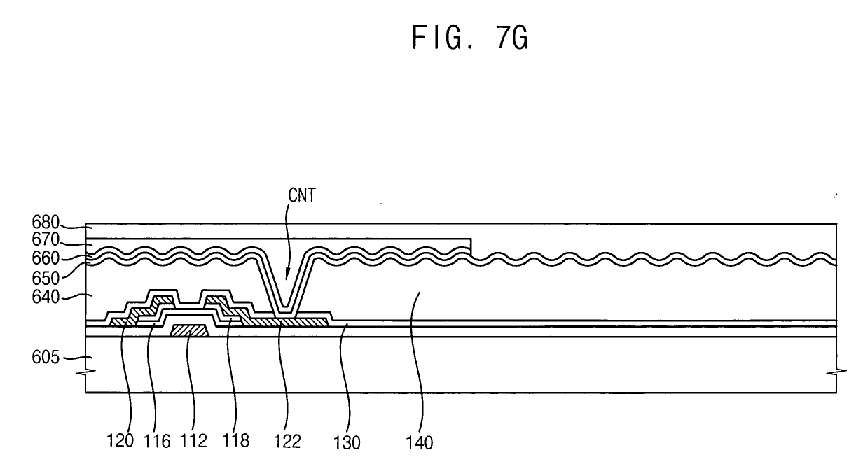

FIGS. 7A through 7G are cross-sectional views illustrating a method of manufacturing the LCD apparatus in FIG. 6.

Referring to FIG. 7A, a metal layer including but not limited to a metal such as tantalum (Ta), titanium (Ti), molybdenum (Mo), aluminum (Al), chromium (Cr), copper (Cu), tungsten (W), etc. is formed on the first transparent substrate 605 including glass, ceramic, etc.

The metal layer is patterned to form a plurality of gate lines and a gate electrode 112 protruded from the gate line.

The gate insulation layer 114 including, for example silicon nitride is formed on the first transparent substrate 105 having the gate lines and the gate electrode 112 to cover the gate lines and the gate electrode 112. The gate insulation layer 114 may be formed on all portions of an upper surface of the first transparent substrate 105. Alternatively, the gate insulation layer 114 may be formed on only portions of the upper surface of the first transparent substrate 105 such that the gate insulation layer 114 covers the gate line and the gate electrode 112.

An amorphous silicon (a-Si) layer is formed on the gate insulation layer 114 and n+ amorphous silicon (n+ a-Si) layer is formed on the amorphous silicon layer. The amorphous silicon layer and the n+ amorphous silicon layer are patterned to form the semiconductor layer 116 and the ohmic contact layer 118 of the thin film transistor, respectively.

A metal layer including but not limited to a metal such as tantalum (Ta), titanium (Ti), molybdenum (Mo), aluminum (Al), chromium (Cr), copper (Cu), tungsten (W), etc. is formed on the first transparent substrate 105 having the semiconductor layer 116 and the ohmic contact layer 118. The metal layer is patterned to form the plurality of source lines, the source electrode 120 protruding from the source lines, and the drain electrode 122 which is spaced apart from the source electrode 120.

Referring to FIG. 7B, the passivation layer 130 is formed on the first transparent substrate 105 having the plurality of source lines, the source electrode 120 and the drain electrode 122, such as by way of, e.g. a spin coating method. A first primitive organic insulation layer 640-b is formed on the passivation layer 130.

Referring to FIG. 7C, a portion of the first primitive organic insulation layer 640-b is removed to form a primitive connection hole that exposes a portion of the passivation layer 130, and embossing patterns are formed on an upper surface of the first primitive organic insulation layer 640-b to form a second primitive organic insulation layer 640-c. For example, a photo mask MA having a transparent base substrate MA1 and opaque patterns MA2 are disposed over the first primitive organic insulation layer 640-b. The opaque patterns MA2 are formed on the transparent base substrate MA1. The first primitive organic insulation layer 640-b is exposed and developed to form primitive embossing patterns, so that the second primitive organic insulation layer 640-c is completed.

Referring to FIG. 7D, the portion of the passivation layer 130 is removed to form the connection hole CNT that exposes a portion of the drain electrode 122. Then, a reflow-process is performed to smoothen a surface of the primitive embossing patterns of the second organic insulation layer 640-c, so that the embossing patterns of the organic insulation layer 640 are formed.

Referring to FIG. 7E, the pixel electrode layer 650 is formed on the organic insulation layer 640. The pixel electrode layer 650 is electrically connected to the drain electrode 122 through the contact hole CNT. The pixel electrode layer 650 includes an optically transparent and electrically conductive material such as indium tin oxide (ITO), indium zinc oxide (IZO), zinc oxide (ZO), etc. The pixel electrode layer 650 may be formed on a portion of an upper surface of the organic insulation layer 640, which corresponds to pixel region. Alternatively, the pixel electrode layer 650 is formed on all portions of the upper surface of the organic insulation layer 640, and the pixel electrode layer 650 may be patterned.

A metal layer including but not limited to a metal or a metal alloy such as aluminum (Al), silver (Ag), aluminum neodymium (AlNd), etc. are formed on the pixel electrode layer 650, and the metal layer is patterned to form the reflective plate 660. The reflective plate 660 has a relatively thin thickness, so that the reflective plate 660 has the same or at least substantially the same surface shape as that of the pixel electrode layer 650 and the organic insulation layer 640. In other words, the reflective plate 660 also includes embossing patterns. As a result, the reflective plate 660 resembles a plurality of convex mirrors and a plurality of concave mirrors.

Referring to FIGS. 7F and 7G, a primitive inner polarization layer 670-b is formed on the reflective plate 660 and the pixel electrode layer 650. For example, a disc type liquid crystal layer that corresponds to the primitive inner polarization layer 670-b is formed on reflective plate 660 and the pixel electrode layer 650, for example through a slit coating method, wherein a shear stress is applied along a desired polarization axis. The disc type liquid crystal layer is pre-cured, and a portion of the disc type liquid crystal layer, which corresponds to the transmissive region, is removed, for example through a wet-etching process or dry etching process. In addition, a mask MA having a transparent base substrate MA1 with an opaque pattern MA2 is disposed over the primitive inner polarization layer 670-b. For example, the opaque pattern MA2 corresponds to a reflective region. Then, the disc type liquid crystal layer is exposed and developed, and a portion of the disc type liquid crystal layer, which corresponds to the transmissive region, is removed to form the inner polarization layer 670 in the reflective region.

Referring to FIG. 7G, the first alignment layer 680 is formed on the inner polarization layer 670 of the reflective region and the pixel electrode layer 650 of the transmissive region, for example through a polyimide printing process.

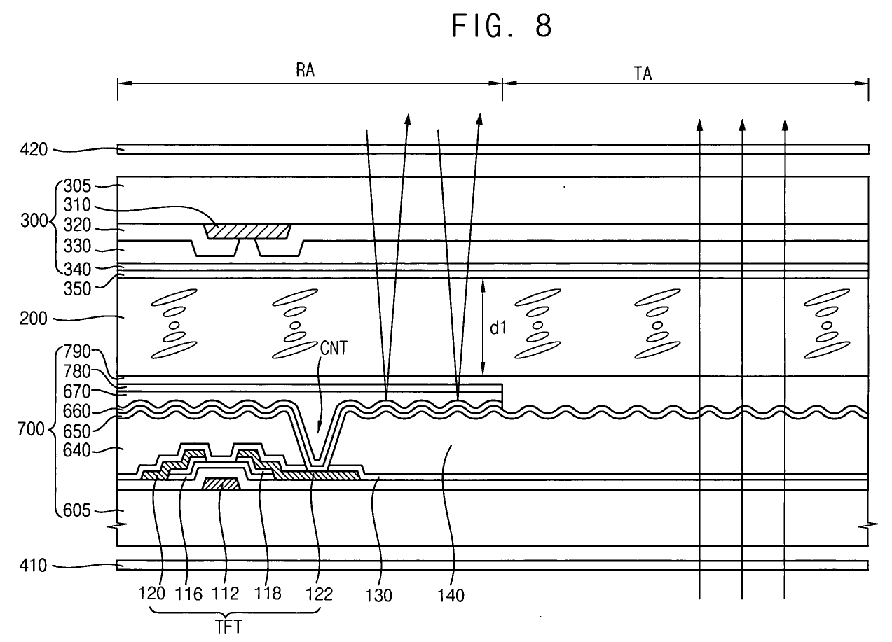

FIG. 8 is a cross-sectional view illustrating an LCD apparatus having a signal gap structure according to an exemplary embodiment of the present invention.

Referring to FIG. 8, a liquid crystal display (LCD) panel includes an array substrate 700, a liquid crystal layer 200, a color filter substrate 300, a first polarization plate 410 and a second polarization plate 420. The array substrate 700 and the color filter substrate 300 are combined with each other. The liquid crystal layer 200 is disposed between the array substrate 700 and the color filter substrate 300. The first polarization plate 410 is disposed on a lower face of the array substrate 700, and the second polarization plate 420 is disposed on an upper face of the color filter substrate 200. The first and second polarization plates 410 and 420 have different polarization axis from each other. For example, a polarization axis of the first polarization plate 410 is substantially perpendicular to a polarization axis of the second polarization plate 420. The LCD panel of the present embodiment is same as the exemplary embodiment depicted in FIG. 6 except for a planarization layer 770 and an inner polarization layer 780. Thus, the same reference numerals will be used to refer to the same or like parts as those described in the exemplary embodiment depicted in FIG. 6 and any further explanation concerning the above elements will be omitted.

The array substrate 700 includes the planarization layer 770, the inner polarization layer 780 and the first alignment layer 790. The planarization layer 770 is formed on the reflective plate 660 having embossing patterns. The inner polarization layer 780 is formed on the planarization layer 770. The first alignment layer 790 is formed on the inner polarization layer 780. The reflective plate 660, the planarization layer 770, the inner polarization layer 780 are disposed at the reflective region RA. The inner polarization layer 780 and the first polarization plate 410 have substantially parallel polarization axis. The first alignment layer 790 is formed on the inner polarization layer 780 of the reflective region RA and the pixel electrode layer 650 of the transmissive region TA.

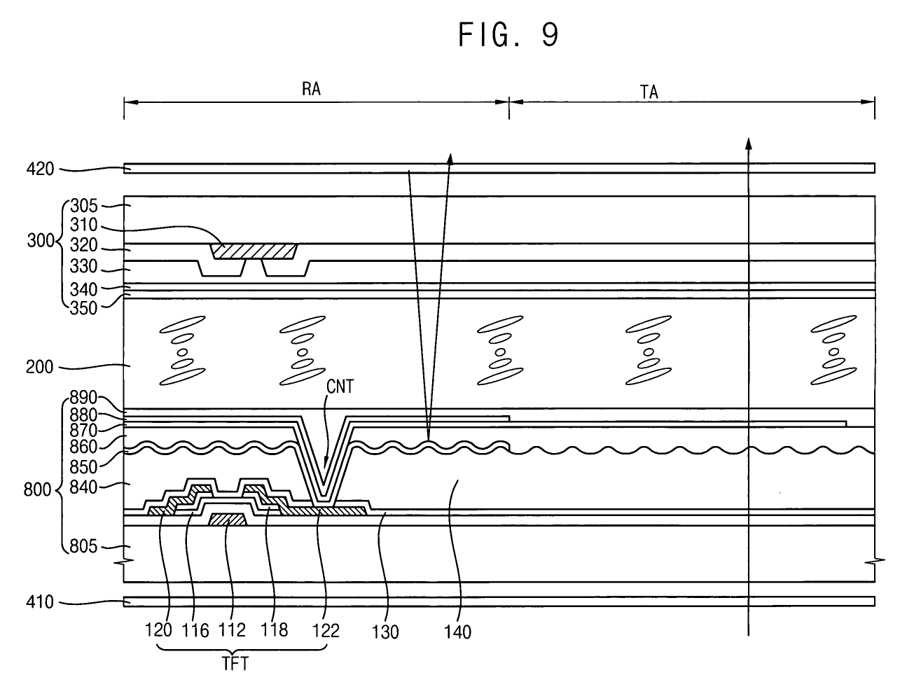

FIG. 9 is a cross-sectional view illustrating an LCD apparatus according to an exemplary embodiment of the present invention.

Referring to FIG. 9, the LCD panel includes an array substrate 800, a liquid crystal layer 200, a color filter substrate 300, a first polarization plate 410 and a second polarization plate 420. The array substrate 800 and the color filter substrate 300 are combined with each other. The liquid crystal layer 200 is disposed between the array substrate 800 and the color filter substrate 300. The first polarization plate 410 is disposed on a lower surface of the array substrate 800, and the second polarization plate 420 is disposed on an upper surface of the color filter substrate 300. The first and second polarization plates 410 and 420 have different polarization axes. For example, the first polarization plate 410 has a polarization axis that is substantially perpendicular to a polarization axis of the second polarization plate 420. The LCD panel of the present exemplary embodiment is same as the exemplary embodiment depicted in FIGS. 1-3G except for the array substrate 800. Thus, the same reference numerals will be used to refer to the same or like parts as those described in the previous exemplary embodiment depicted in FIGS. 1-3G and any further explanation concerning the above elements will be omitted.

The array substrate 800 includes a passivation layer 130, an organic insulation layer 840 and a reflective plate 850. The passivation layer 130 covers the thin film transistor TFT. The passivation layer 130 includes a first sub contact hole that exposes a portion of the drain electrode 122 of the thin film transistor TFT. The passivation layer 130 protects a semiconductor layer 116 and the ohmic contact layer 118 disposed between the source electrode 120 and the drain electrode 122.

The organic insulation layer 840 is disposed on the passivation layer 130. The organic insulation layer 840 includes a second sub contact hole that is connected to the first sub contact hole to expose the portion of the drain electrode 122. The organic insulation layer 840 has embossing patterns.

The reflective plate 850 is disposed on the organic insulation layer 840, so that the reflective plate 850 has embossing patterns induced by the organic insulation layer 840 to enhance optical reflectivity. The reflective plate 850 is electrically connected to the drain electrode 122 through the first and second contact holes. The reflective plate 850 is disposed at the reflective region RA.

The array substrate 800 further includes a planarization layer 860, a pixel electrode layer 870, an inner polarization layer 880 and a first alignment layer 890. The planarization layer 860 is formed on the reflective plate 850 of the reflective region RA and the organic insulation layer 840 of the transmissive region TA. The planarization layer 860 includes a third sub contact hole that exposes a portion of the reflective plate 850.

The pixel electrode layer 870 is formed on the planarization layer 860. The pixel electrode layer 870 is electrically connected to the reflective plate 850 through the third sub contact hole. The pixel electrode layer 870 is disposed at both of the reflective and transmissive regions RA and TA.

The inner polarization layer 880 is formed on the pixel electrode layer 860 of the reflective region RA, so that the inner polarization layer 880 is disposed over the reflective plate 850. The inner polarization layer 880 has a polarization axis that is substantially parallel with a polarization axis of the first polarization plate 410.

The color filter substrate 300 includes a second transparent substrate 305, a light blocking layer 310, a color filter layer 320, an over coating layer 330, a common electrode layer 340 and a second alignment layer 350. The light blocking layer 310 is formed on the second transparent substrate 305. The light blocking layer 310 includes a plurality of openings arranged in a matrix type shape. Each of the openings defines a pixel. The color filter layer 320 is formed on the second transparent substrate 305 exposed through the openings of the light blocking layer 310. The over coating layer 330 is formed on the color filter layer 320. The common electrode layer 330 is formed on the over coating layer 330. The second alignment layer 350 is formed on the common electrode layer 330. The color filter substrate 300 is combined with the array substrate 100 such that the liquid crystal layer 200 is disposed between the color filter substrate 300 and the array substrate 100.

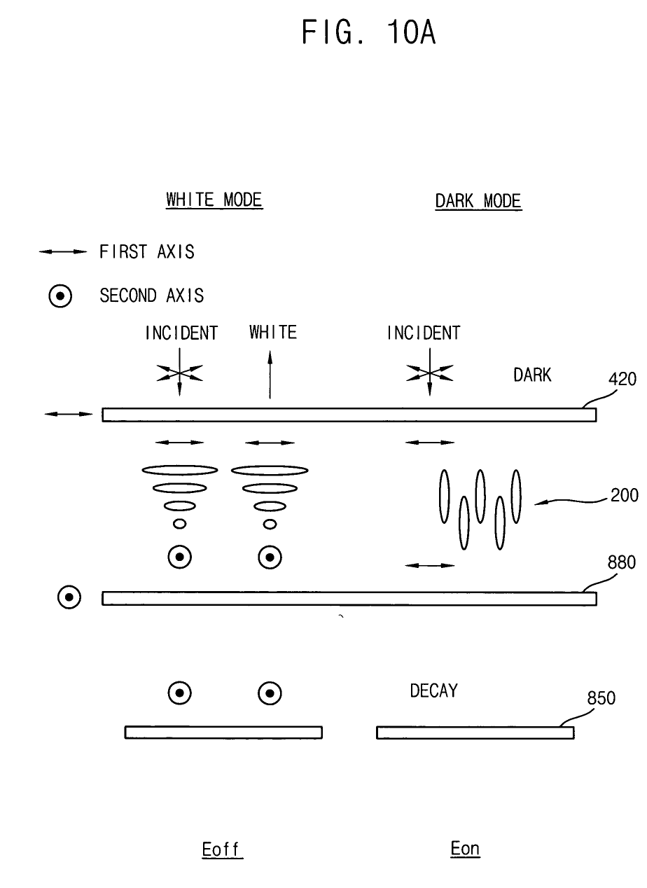

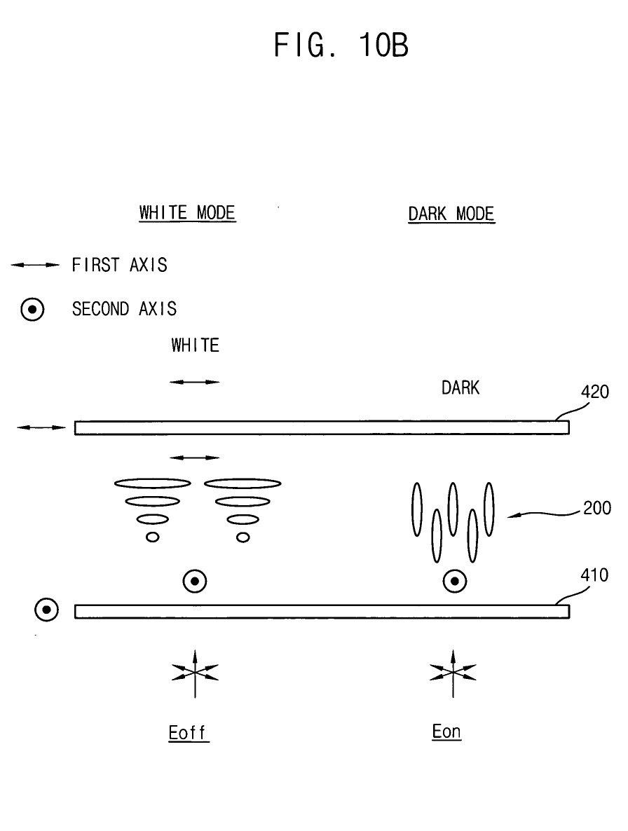

FIGS. 10A and 10B are conceptual views illustrating a light path of the LCD apparatus in FIG. 9. Hereinafter, a ‘first axis’ is defined as an axis that is disposed on a paper of drawings, and a ‘second axis’ is defined as an axis that is substantially in parallel with a normal line of the paper.

Reflective Mode Operation

FIG. 10A corresponds to the reflective mode of the transflective LCD apparatus in FIG. 9.

Referring to FIG. 10A, when external light advances toward the second polarization plate 420, a portion of the light oscillates along the first axis and passes through the second polarization plate 420, and the remaining portion of the light is blocked by the second polarization plate 420. If no electric fields are applied to the liquid crystal layer 200 (Eoff), a portion of the light passes through the liquid crystal layer 200 and is rotated to oscillate along the second axis. The portion of the light that oscillates along the second axis passes through the inner polarization layer 880, because the inner polarization layer 880 has a polarization axis that is substantially perpendicular to a polarization axis of the second polarization plate 420, so that the portion of the light is reflected by the reflective plate 850 and passes through the inner polarization layer 880. The portion of the light that exits from the inner polarization layer 880 enters the liquid crystal layer 200. When the portion of the light exits from the liquid crystal layer 200, this portion of the light is rotated by the liquid crystal layer 200 to pass through the second polarization plate 420, thereby also resulting in white color being displayed.

When electric fields are applied to the liquid crystal layer 200 (Eon), the arrangement of liquid crystal molecules in the liquid crystal layer 200 is changed, so that the portion of light that passes through the second polarization plate 420 passes through the liquid crystal layer 200 without being rotated. Therefore, the portion of light that passes through the liquid crystal layer 200 without being rotated is blocked by the inner polarization layer 880, so that the reflective plate 850 does not reflect light, thereby resulting in black color being displayed.

Transmissive Mode Operation

FIG. 10B corresponds to the transmissive mode of the transflective LCD apparatus in FIG. 9.

Referring to FIG. 10B, light generated from a backlight assembly advances toward the first polarization plate 410. A portion of the light oscillates along the second axis and passes through the first polarization plate 410, and the remaining portion of the light is blocked by the first polarization plate 410. If no electric fields are applied to the liquid crystal layer 200 (Eoff), a portion of the light passes through the liquid crystal layer 200 and is rotated to oscillate along the first axis. The portion of the light that oscillates along the first axis passes through the second polarization plate 420, because the second polarization plate 420 has a polarization axis that is substantially perpendicular to a polarization axis of the first polarization plate 410, thereby also resulting in white color being displayed.

When electric fields are applied to the liquid crystal layer 200 (Eon), the arrangement of liquid crystal molecules in the liquid crystal layer 200 is changed, so that the portion of light that passes through the first polarization plate 410 passes through the liquid crystal layer 200 without being rotated. As a result, the portion of light that passes through the liquid crystal layer 200 without being rotated is blocked by the second polarization plate 420, so that black color is displayed.

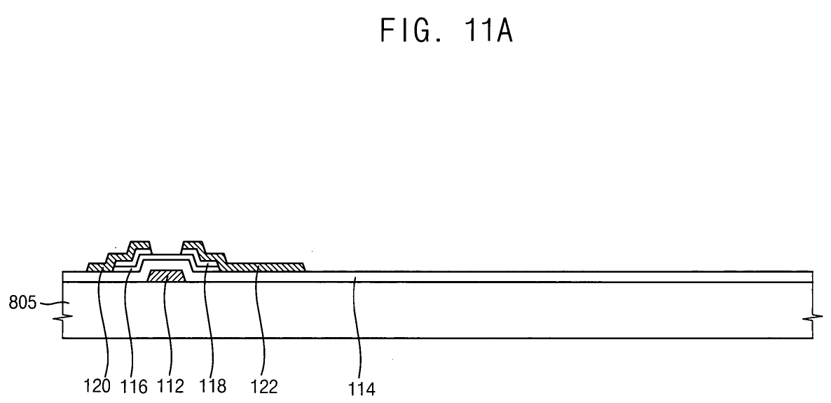

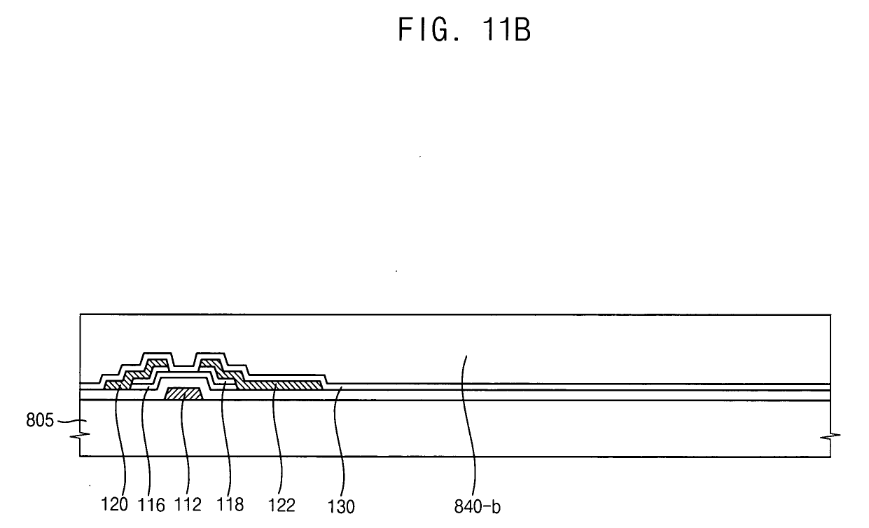

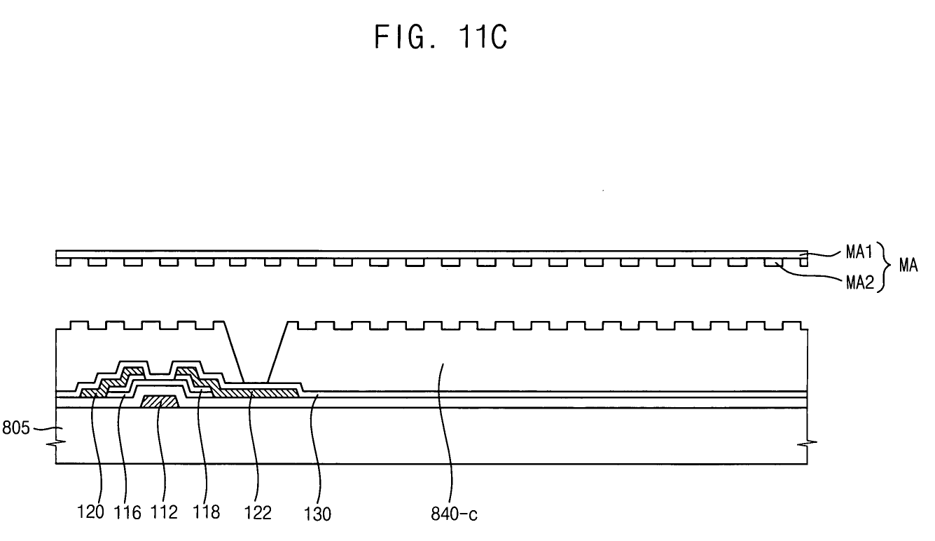

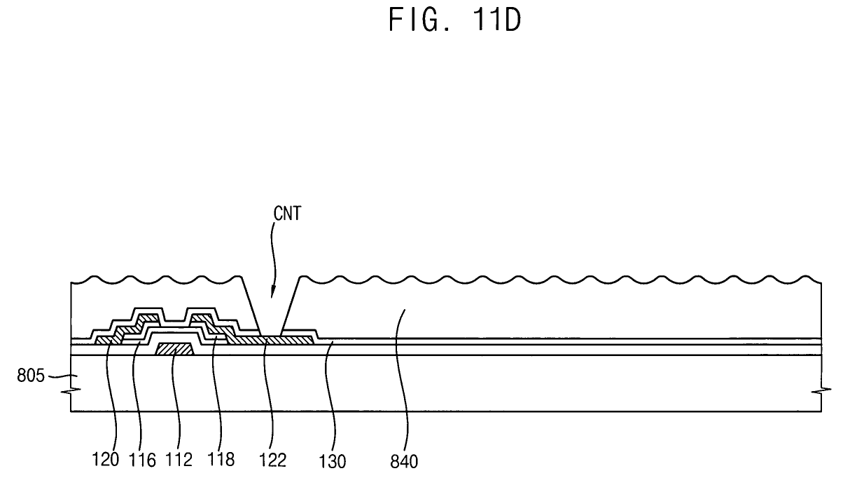

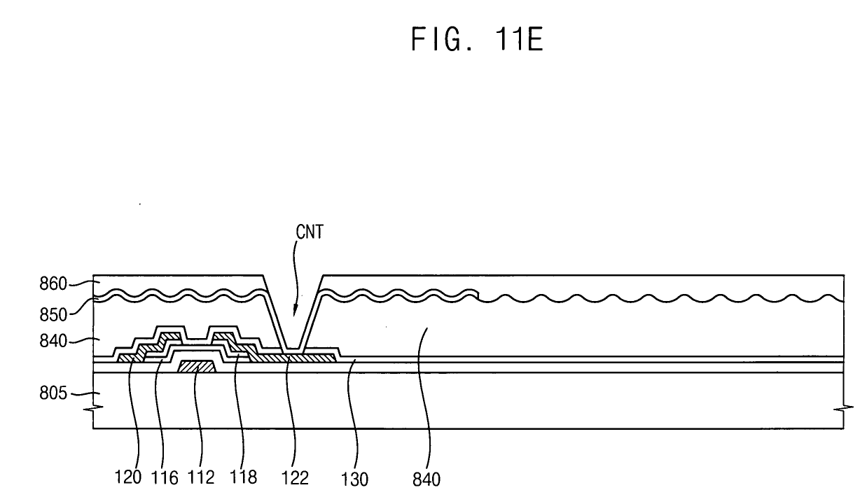

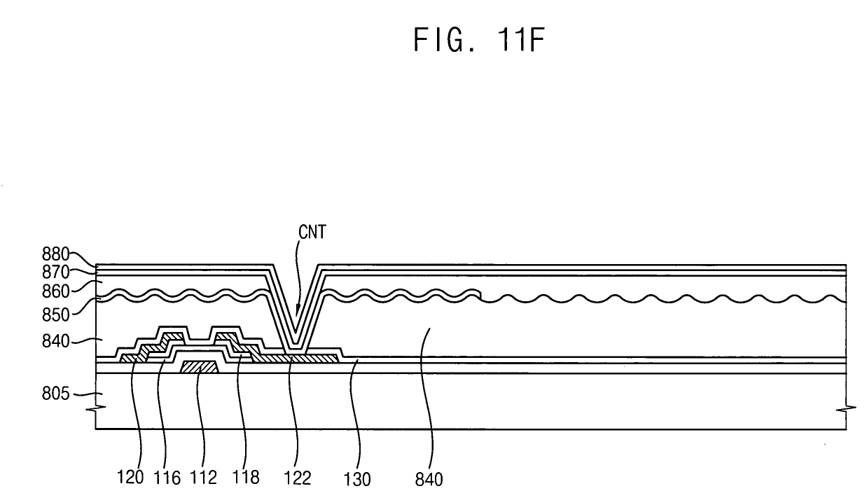

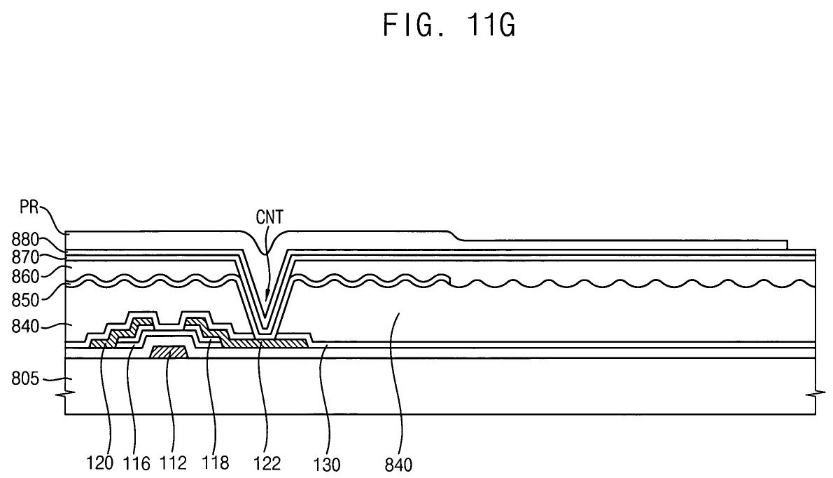

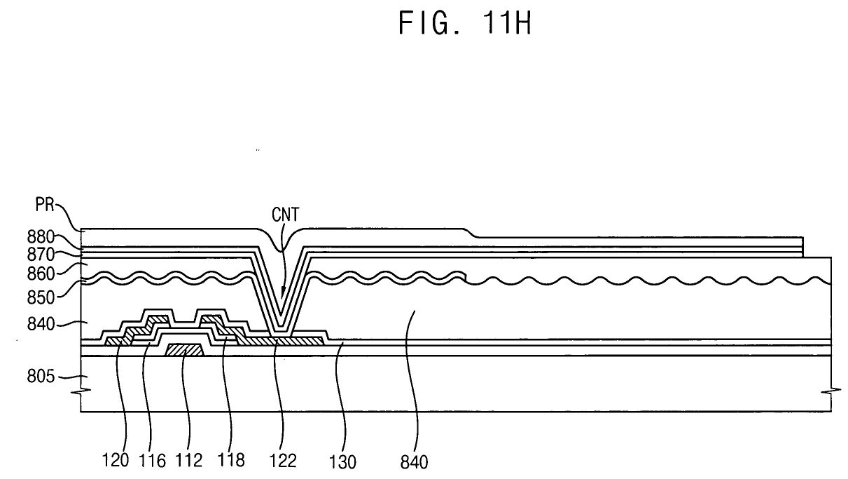

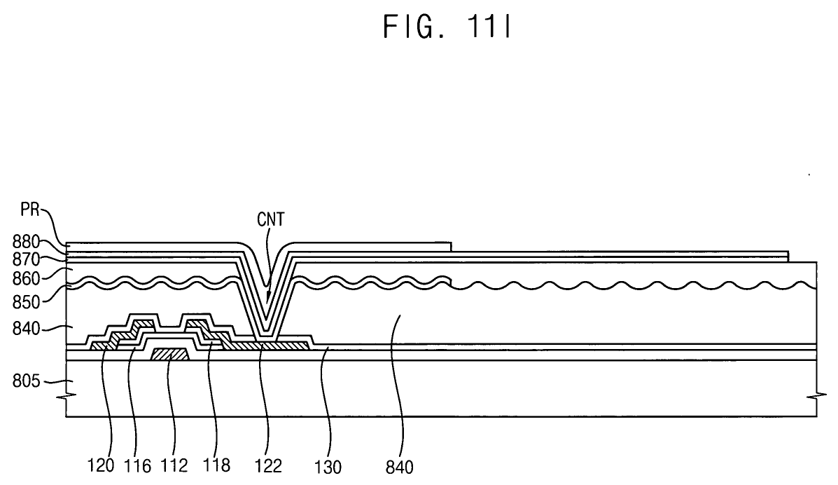

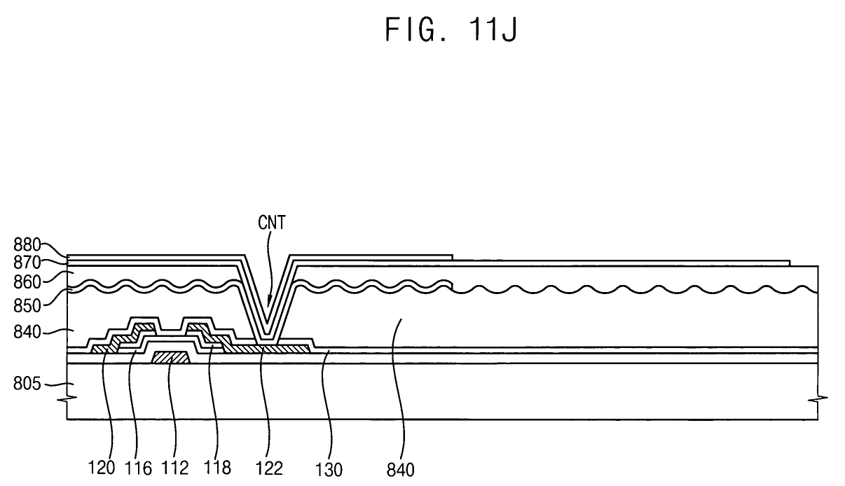

FIGS. 11A through 11J are cross-sectional views illustrating a method of manufacturing the LCD apparatus in FIG. 9.

Referring to FIG. 11A, a metal layer including but not limited to a metal such as tantalum (Ta), titanium (Ti), molybdenum (Mo), aluminum (Al), chromium (Cr), copper (Cu), tungsten (W), etc. is formed on the first transparent substrate 805 including but not limited to glass, ceramic, etc.

The metal layer is patterned to form a plurality of gate lines and a gate electrode 112 protruding from the gate line.

The gate insulation layer 114 including, for example silicon nitride is formed on the first transparent substrate 105 having the gate lines and the gate electrode 112 for covering the gate lines and the gate electrode 112. The gate insulation layer 114 may be formed on all portions of an upper surface of the first transparent substrate 105. Alternatively, the gate insulation layer 114 may be formed on only portions of the upper surface of the first transparent substrate 105 such that the gate insulation layer 114 covers the gate line and the gate electrode 112.

In addition, an amorphous silicon (a-Si) layer is formed on the gate insulation layer 114 and n+ amorphous silicon (n+ a-Si) layer is formed on the amorphous silicon layer. The amorphous silicon layer and the n+ amorphous silicon layer are patterned to form the semiconductor layer 116 and the ohmic contact layer 118 of the thin film transistor, respectively.

A metal layer including but not limited to a metal such as tantalum (Ta), titanium (Ti), molybdenum (Mo), aluminum (Al), chromium (Cr), copper (Cu), tungsten (W), etc. is formed on the first transparent substrate 805 having the semiconductor layer 116 and the ohmic contact layer 118. The metal layer is patterned to form a plurality of source lines, source electrode 120 protruding from the source lines, and drain electrode 122 which is spaced apart from the source electrode 120.

Referring to FIG. 11B, the passivation layer 130 is formed on the first transparent substrate 805 having the plurality of source lines, the source electrode 120 and the drain electrode 122, by way of, e.g. a spin coating method. A first primitive organic insulation layer 840-b is formed on the passivation layer 130.

Referring to FIG. 11C, a portion of the first primitive organic insulation layer 840-b is removed to form a primitive connection hole that exposes a portion of the passivation layer 130, and embossing patterns are formed on an upper surface of the first primitive organic insulation layer 840-b to form a second primitive organic insulation layer 840-c. For example, a photo mask MA having a transparent base substrate MA1 and opaque patterns MA2 is disposed over the first primitive organic insulation layer 840-b. The opaque patterns MA2 are formed on the transparent base substrate MA1. The first primitive organic insulation layer 840-b is exposed and developed to form primitive embossing patterns, so that the second primitive organic insulation layer 840-c is completed.

Referring to FIG. 11D, a portion of the passivation layer 130 is removed to form the connection hole CNT that exposes a portion of the drain electrode 122. Then, a reflow-process is performed to smoothen a surface of the primitive embossing patterns of the second organic insulation layer 840-c, so that the embossing patterns of the organic insulation layer 840 are formed.

Referring to FIG. 11E, the reflective plate 850 is formed on the organic insulation layer 840. The planarization layer 860 is then formed on the reflective plate 850 of the reflective region RA and the organic insulation layer 840 of the transmissive region TA.

A metal layer including but not limited to a metal or a metal alloy such as aluminum (Al), silver (Ag), aluminum neodymium (AlNd), etc. is formed on the organic insulation layer 840. The metal layer is patterned to form the reflective plate 850 which is electrically connected to the drain electrode 122. The reflective plate 850 has a relatively thin thickness, so that the reflective plate 850 has the same or at least the same surface shape as that of the organic insulation layer 840. In other words, the reflective plate 850 also includes embossing patterns. As a result, the reflective plate 850 resembles a plurality of convex mirrors and a plurality of concave mirrors.

Referring to FIG. 11F, the pixel electrode layer 870 is formed on the planarization layer 860, and the inner polarization layer 880 is formed on the pixel electrode layer 870.

Moreover, pixel electrode layer 870 defines a pixel electrode in a unit pixel region. The pixel electrode layer 870 is electrically connected to the reflective plate 850 which is electrically connected to the drain electrode 122, through the connection hole CNT. The pixel electrode layer 870 includes an optically transparent and electrically conductive material such as indium tin oxide (ITO), indium zinc oxide (IZO), zinc oxide (ZO), etc. The pixel electrode layer 870 may be formed on a portion of an upper surface of the planarization layer 860, which corresponds to pixel region. Alternatively, the pixel electrode layer 870 may be formed on all portions of the upper surface of the planarization layer 860, and the pixel electrode layer 870 may be patterned.

The inner polarization layer 880 includes a disc type liquid crystal. The disc type liquid crystal is coated on the pixel electrode layer 870, for example through a slit coating method, wherein a shear stress is applied along a desired polarization axis. The disc type liquid crystal is pre-cured.

Referring to FIG. 11G, a photoresist layer PR is formed on the inner polarization layer 880. The photoresist layer PR is formed to have a relatively thick thickness at the reflective region RA and a relatively thin thickness at the transmissive region TA, for example through use of a half-tone mask. Alternatively, a thickness of the photoresist layer PR may be adjusted through a slit mask.

Referring to FIG. 11H, a portion of the inner polarization layer 880 and a portion of the pixel electrode layer 870, which are not covered by the photoresist layer PR, are removed through a wet etching process or a dry etching process.

Referring to FIG. 11I, the photoresist layer PR is etched such that a first portion of the photoresist layer PR, which has a relatively thin thickness and is disposed at the transmissive region TA, is removed, and a second portion of the photoresist layer PR, which has a relatively thick thickness and is disposed at the reflective region RA, is retained.

Referring to FIG. 11J, a portion of the inner polarization layer 880, which is not covered by the photoresist layer PR, is removed, for example through a wet etching process or a dry etching process. As a result of the above process, the reflective plate 850, the planarization layer 860 disposed on the reflective plate 850, the pixel electrode layer 870 disposed on the planarization layer 860, and the inner polarization layer 880 disposed on the pixel electrode layer 870 are now disposed at the reflective region RA. Further, the planarization layer 860 disposed on the organic insulation layer 840, and the pixel electrode 870 disposed on the planarization layer 860 are now disposed at the transmissive region TA.

Then, the first alignment layer 890 in FIG. 9 is formed on the inner polarization layer 880 of the reflective region RA, and the pixel electrode layer 870 of the transmissive region TA.

Additionally, to simplify the manufacturing process of the array substrate, after a photo process of forming the gate electrode 112, the active layer including the semiconductor layer 116 and the ohmic contact layer 118, the source and drain electrodes 120 and 122, the passivation layer 130, the contact hole and the embossing patterns and the planarization layer, the pixel electrode layer 870 and the inner polarization layer 880 may be formed through a similar photo process as the above-mentioned components.

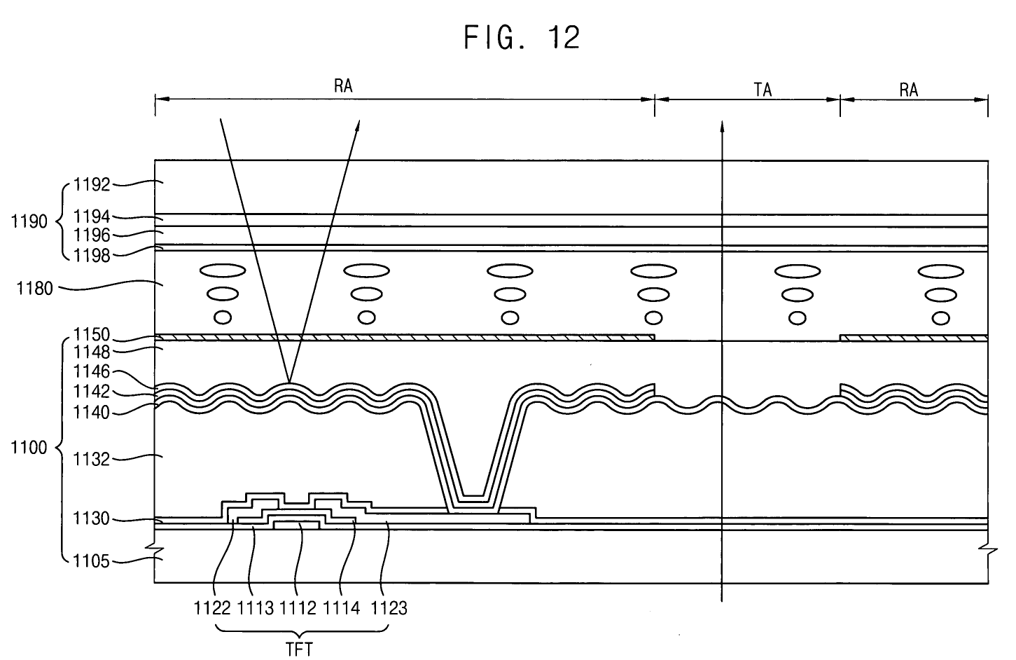

FIG. 12 is a cross-sectional view illustrating an LCD apparatus according to an exemplary embodiment of the present invention.

Referring to FIG. 12, an LCD panel includes an array substrate 1100, a liquid crystal layer 1180 and a color filter substrate 1190. The array substrate 1100 and the color filter substrate 1190 are combined with each other, and the liquid crystal layer 1180 is disposed between the array substrate 1100 and the color filter substrate 1190. In addition, a first polarization plate is disposed on a lower surface of the array substrate 1100 and a second polarization plate is disposed on an upper surface of the color filter substrate 1190. The first and second polarization plates have different polarization axes. For example, the first polarization plate has a polarization axis that is substantially perpendicular to a polarization axis of the second polarization plate.

The array substrate 1100 includes a first transparent substrate 1105, a gate line, a gate electrode 1112 and a gate insulation layer 1113. The gate line is formed on the first transparent substrate 1105, and the gate electrode 1113 protrudes from the gate line. The gate insulation layer 1113 is formed on the first transparent substrate 1105 such that the gate insulation layer 1113 covers the gate line and the gate electrode 1112. The gate insulation layer 1113 includes, for example silicon nitride (SiNx). The gate line and the gate electrode 1112 include but are not limited to a metal or a metal alloy such as aluminum (Al), aluminum alloy, silver (Ag), silver alloy, copper (Cu), copper alloy, molybdenum (Mo), molybdenum alloy, chromium (Cr), tantalum (Ta), titanium (Ti), etc.

The array substrate 1100 further includes a channel layer 1114, a source electrode 1122 and a drain electrode 1123. The channel layer 1114 covers the gate electrode 1112. The source and drain electrodes 1122 and 1123 are spaced apart from each other, and the source and drain electrodes 1122 and 1123 cover a portion of the channel layer 1114.

The channel layer 1114 includes, a semiconductor layer including for example amorphous silicon (a-Si), and the ohmic contact layer including, for example n-doped amorphous silicon (a-Si).

The gate electrode 1112, the channel layer 1114, the source electrode 1122 and the drain electrode 1123 form a thin film transistor (TFT). The source and drain electrodes 1122 and 1123 include but are not limited to a metal or a metal alloy such as aluminum (Al), aluminum alloy, silver (Ag), silver alloy, copper (Cu), copper alloy, molybdenum (Mo), molybdenum alloy, chromium (Cr), tantalum (Ta), titanium (Ti), etc.

The gate, source and drain electrodes 1112, 1122 and 1123 have, for example a single layered structure. Alternatively, one of the gate, source and drain electrodes 1112, 1122 and 1123 may have a multi-layered structure. When the gate, source and drain electrodes 1112, 1122 and 1123 have a single layered structure, the gate, source and drain electrodes 1112, 1122 and 1123 include but are not limited to a metal or a metal alloy such as aluminum (Al), aluminum neodymium (AlNd), copper (Cu), etc. When the gate, source and drain electrodes 1112, 1122 and 1123 have, for example a double layered structure including a lower layer and an upper layer, the lower layer include but are not limited to a metal or a metal alloy such as chromium (Cr), molybdenum (Mo), molybdenum alloy, etc., and the upper layer includes a metal or a metal alloy such as aluminum, aluminum alloy, etc.

The array substrate 1100 further includes a passivation layer 1130, an organic insulation layer 1132 and a pixel electrode layer 1140. The passivation layer 1130 includes a contact hole that exposes a portion of the drain electrode 1123. The passivation layer 1130 protects the channel layer 1114 disposed between the source and drain electrodes 1122 and 1123. The pixel electrode layer 1140 is disposed at both of a reflective region RA and a transmissive region TA.

The organic insulation layer 1132 is formed on the passivation layer 1130. The organic insulation layer 160 includes a contact hole that exposes a portion of the drain electrode 1123. The organic insulation layer 1132 includes a photosensitive material, so that the contact hole is easily formed through a photolithography process. When the LCD panel does not utilize a contact hole, the organic insulation layer 1132 may include a material that is not photosensitive. The organic insulation layer 1132 includes a material having a relatively high optical transmittance of substantially equal to or more than about 90%. The organic insulation layer 1132 has embossing patterns, and the embossing patterns are formed on an upper surface of the organic insulation layer 1132.

The pixel electrode layer 1140 is formed on the organic insulation layer 1132. The pixel electrode layer 1140 is electrically connected to the drain electrode 1123 through the contact hole.

The array substrate 1100 further includes a buffer metal layer 1142, a reflective plate 1146, a planarization layer 1148 and an inner polarization layer 1150. The buffer metal layer 1142 covers the pixel electrode layer 1140 of the reflective region RA. The reflective plate 1146 is formed on the buffer metal layer 1142. The planarization layer 1148 is formed on the reflective plate 1146 of the reflective region RA and the pixel electrode layer 1140 of the transmissive region TA. The inner polarization layer 1150 is formed on the planarization layer 1148 of the reflective region RA.

The buffer metal layer 1142 reduces contact resistance between the pixel electrode layer 1140 and the reflective plate 1146. The buffer metal layer 1142 includes, for example molybdenum tungsten (MoW).

The planarization layer 1148 includes a material that has a relatively high optical transmittance. Moreover, the planarization layer 1148 and the organic insulation layer 1132 preferably are comprised of the same material.

When the planarization layer 1148 includes different material from that of the organic insulation layer 1132, a ratio of optical refractivity of the planarization layer 1148 to optical refractivity of the organic insulation layer 1132 is in a range of about a half to about one. That is because when an optical difference between the planarization layer 1246 and the organic insulation layer 1132 increases, the light-using efficiency is reduced.

Preferably, the planarization layer 180 has a relatively thin thickness, provided that the planarization layer 180 levels the embossing patterns. For example, when the embossing patterns have a height of about 0.5 μm, the planarization layer 180 preferably has a thickness of about 0.5 μm.

The inner polarization layer 1150 has a polarization axis that is substantially parallel with a polarization axis of the first polarization plate that is disposed on a lower surface of the array substrate 1100.

The array substrate 1100 may further include an alignment layer formed on the inner polarization layer 1150.

The color filter substrate 1190 includes a second transparent substrate 1192, a light blocking layer, a color filter layer 1194, an over coating layer 1196, and a common electrode layer 1198. The light blocking layer is formed on the second transparent substrate 1192 and includes a plurality of openings arranged in a matrix type shape. Each of the openings defines a pixel. The color filter layer 1194 is formed on the second transparent substrate 1192 exposed through the openings of the light blocking layer. The over coating layer 1196 is formed on the color filter layer 1194. The common electrode layer 1198 is formed on the over coating layer 1196. The color filter substrate 1190 may further include a second alignment layer formed on the common electrode layer 1198.

The color filter substrate 1190 is combined with the array substrate 1100 such that the liquid crystal layer 1180 is disposed between the color filter substrate 1190 and the array substrate 1100. The liquid crystal layer has a single cell gap.

According to the present exemplary embodiment, the buffer layer 1142 is disposed between the pixel electrode layer 1140 and the reflective plate 1146 to reduce a contact resistance between the pixel electrode layer 1140 including, for example ITO and the reflective plate 1146 including a metal.

The planarization layer 1148 is formed on the reflective plate 1146 having the embossing patterns to enhance optical reflectivity. The thin crystal film (TCF®) of Optiva Inc. in U.S.A may be coated on the planarization layer 1148, for example through a slot die coating method. Moreover, to form the inner polarization layer 1150, a shear stress is applied to the thin crystal film along a polarization axis in order to form the inner polarization layer 1150. The thin crystal film includes dyestuff of chromogen base.

The thin crystal film having above described optical characteristics may be employed by a transflective LCD apparatus for enhancing the display quality of the transfiective LCD apparatus. As discussed, a typical transflective LCD apparatus includes both the reflective plate and transmissive window. By using a thin crystal film according to the exemplary embodiments of the present invention with a transflective LCD apparatus, a transflective LCD apparatus having a relatively high transmittance at the reflective region RA and a relatively high contrast ratio at the transmissive region is provided, thereby enhancing the display quality of the apparatus.

The thin crystal film corresponds to a polymer resin that is gel type and has a viscosity of about 300 psi. The thin crystal film may be formed, for example by the slot die coating method.

Hereinafter, a transmissive mode operation and a reflective mode operation of the transfiective LCD apparatus according to the present exemplary embodiment will be explained. The transfiective LCD apparatus that will be explained displays white color when no electric fields are applied to the liquid crystal layer 1180. In other words, the transfiective LCD apparatus corresponds to a normally white mode. The transflective LCD apparatus includes a first polarization plate that has a first polarization axis disposed on the lower surface of the first transparent substrate 1105, inner polarization layer 1150 that has a polarization axis that is substantially is parallel with the first polarization axis, and the second polarization plate that has a second polarization axis that is substantially perpendicular to the first polarization axis and is disposed on the upper surface of the second transparent substrate 1192.

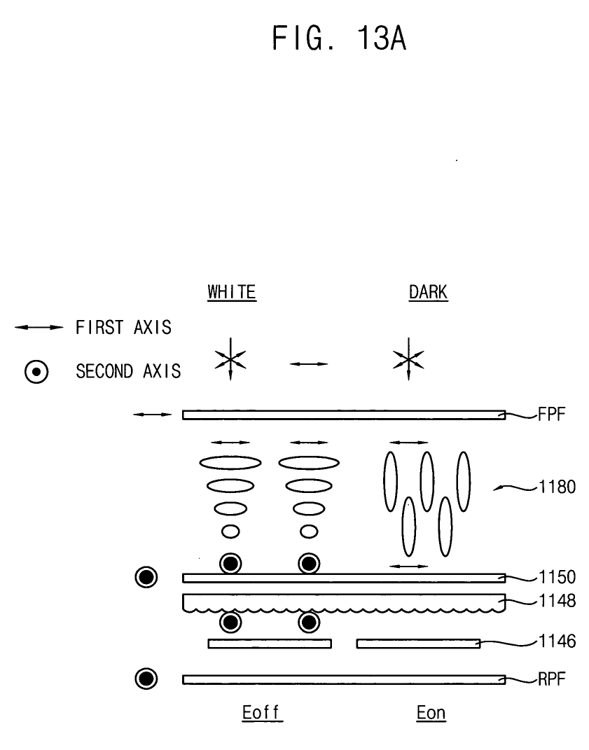

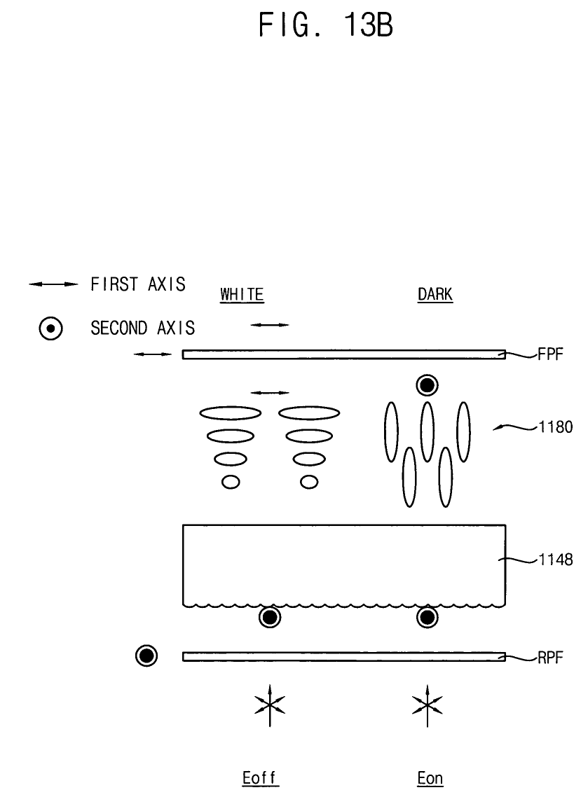

FIGS. 13A and 13B are conceptual views illustrating a light path of the LCD apparatus in FIG. 12. Hereinafter, a ‘first axis’ is defined as an axis that is disposed on a paper of drawings, and a ‘second axis’ is defined as an axis that is substantially parallel with a normal line of the paper.

Reflective Mode Operation

FIG. 13A corresponds to the reflective mode of the transflective LCD apparatus in FIG. 12.

Referring to FIG. 13A, when external light advances toward the second polarization plate FPF, a portion of the light oscillates along the first axis and passes through the second polarization plate FPF, and the remaining portion of the light is blocked by the second polarization plate FPF. If no electric fields are applied to the liquid crystal layer 1180 (Eoff), a portion of the light passes through the liquid crystal layer 1180 and is rotated to oscillate along the second axis. The portion of the light that oscillates along the second axis passes through the inner polarization layer 1150, because the inner polarization layer 1150 has a polarization axis that is substantially perpendicular to a polarization axis of the second polarization plate FPF. The portion of light that passes through the inner polarization layer 1150 passes through the planarization layer 1148, so that this portion of the light is reflected by the reflective plate 1146 and passes through the planarization layer 1148 and the inner polarization layer 190 in sequence. The portion of the light that exits from the inner polarization layer 1150 enters the liquid crystal layer 1180. When the portion of the light exits from the liquid crystal layer 1180, this portion of the light is rotated by the liquid crystal layer 1180 to passes through the second polarization plate FPF, thereby resulting in white color being displayed.

When electric fields are applied to the liquid crystal layer 1180 (Eon), the arrangement of liquid crystal molecules in the liquid crystal layer 1180 is changed, so that the portion of light that passes through the second polarization plate FPF passes through the liquid crystal layer 1180 without being rotated. As a result, the portion of light that passes through the liquid crystal layer 1180 without being rotated is blocked by the inner polarization layer 1150, so that the reflective plate 1146 does not reflect light, thereby resulting in black color being displayed.

Transmissive Mode Operation

FIG. 13B corresponds to the transmissive mode of the transflective LCD apparatus in FIG. 12.

Referring to FIG. 13B, light generated from a backlight assembly advances toward the first polarization plate RPF. A portion of that light oscillates along the second axis and passes through the first polarization plate RPF. The remaining portion of the light is blocked by the first polarization plate RPF. If no electric fields are applied to the liquid crystal layer 1180 (Eoff), a portion of the light passes through the liquid crystal layer 1180 and is rotated to oscillate along the first axis. The portion of the light that oscillates along the first axis passes through the second polarization plate FPF, because the second polarization plate FPF has a polarization axis that is substantially perpendicular to a polarization axis of the first polarization plate RPF, thereby resulting in white color being displayed.

When electric fields are applied to the liquid crystal layer 1180 (Eon), the arrangement of liquid crystal molecules in the liquid crystal layer 1180 is changed, so that the portion of light that passes through the first polarization plate RPF passes through the liquid crystal layer 1180 without being rotated. As a result, the portion of light that passes through the liquid crystal layer 1180 without being rotated is blocked by the second polarization plate FPF, so that black color is displayed.

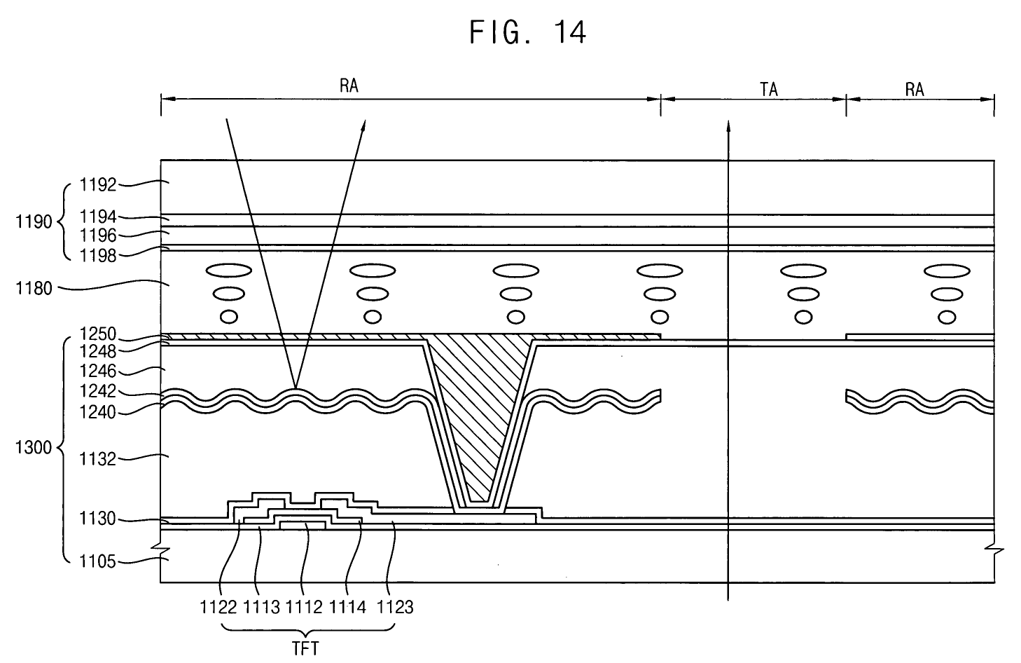

FIG. 14 is a cross-sectional view illustrating an LCD apparatus according to an exemplary embodiment of the present invention.

Referring to FIG. 14, the LCD panel includes an array substrate 1200, a liquid crystal layer 1180 and a color filter substrate 1190. The array substrate 1200 and the color filter substrate 1190 are combined with each other, and the liquid crystal layer 1180 is disposed between the array substrate 1200 and the color filter substrate 1190. Additionally, a first polarization plate is disposed on a lower surface of the array substrate 1200 and a second polarization plate is disposed on an upper surface of the color filter substrate 1190. The first and second polarization plates have different polarization axes. For example, the first polarization plate has a polarization axis that is substantially perpendicular to a polarization axis of the second polarization plate. The LCD panel of the present exemplary embodiment is the same as the previous exemplary embodiment depicted in FIGS. 12-13B except for the array substrate 1200. Thus, the same reference numerals will be used to refer to the same or like parts as those described in the exemplary embodiment depicted in FIGS. 12-13B and any further explanation concerning the above elements will be omitted.

The array substrate 1200 includes a buffer metal layer 1240, a reflective plate 1242, a planarization layer 1246, a pixel electrode layer 1248 and an inner polarization layer 1250. The buffer metal layer 1240 is formed on an organic insulation layer 1132 having embossing patterns. The buffer metal layer 1240 is electrically connected to a drain electrode 1123 through a contact hole of the organic insulation layer 1132. The buffer metal layer 1240 is disposed at the reflective region RA. The reflective plate 1242 is formed on the buffer metal layer 1240 of the reflective region RA. The planarization layer 1246 is formed on the reflection plate 1242 of the reflective region RA and the organic insulation layer 1132 of the transmissive region TA. The pixel electrode layer 1248 is formed on the planarization layer 1246. The pixel electrode layer 1248 is electrically connected to the reflective plate 1242. The inner polarization layer 1250 is formed on the pixel electrode layer 1248 of the reflective region RA.

The ratio of optical refractivity of the planarization layer 1148 to optical refractivity of the organic insulation layer 1132 is in a range of about a half to about one. That is because when an optical difference between the planarization layer 1246 and the organic insulation layer 1132 increases, light-using efficiency is reduced.

The inner polarization layer 1250 has a polarization axis that is substantially parallel with a polarization axis of the first polarization plate which is disposed on the lower surface of the first transparent substrate 1105.

The color filter substrate 1190 includes a second transparent substrate 1192, a light blocking layer, a color filter layer 1194, an over coating layer 1196, and a common electrode layer 1198. The light blocking layer is formed on the second transparent substrate 1192. The light blocking layer includes a plurality of openings arranged in a matrix type shape. Each of the openings defines a pixel. The color filter layer 1194 is formed on the second transparent substrate 1192 exposed through the openings of the light blocking layer. The over coating layer 1196 is formed on the color filter layer 1194. The common electrode layer 1198 is formed on the over coating layer 1196. The color filter substrate 1190 may further include a second alignment layer formed on the common electrode layer 1198.

The color filter substrate 1190 is combined with the array substrate 1100 such that the liquid crystal layer 1180 is disposed between the color filter substrate 1190 and the array substrate 1100. The liquid crystal layer has a single cell gap.

According to the present exemplary embodiment, the organic insulation layer 1132 includes a photosensitive material, so that the contact hole is easily formed through a photolithography process.

When the LCD panel does not utilize a contact hole, the organic insulation layer 1132 may instead include a material that is not photosensitive.

Further, according to the present exemplary embodiment, the pixel electrode layer 1248 is formed on the planarization layer 1246 and the inner polarization layer 1250 is formed on the pixel electrode layer 1248 in sequence. In other words, the pixel electrode layer 1248 is disposed between the planarization layer 1246 and the inner polarization layer 1250, so that the stability of manufacturing process is further enhanced.

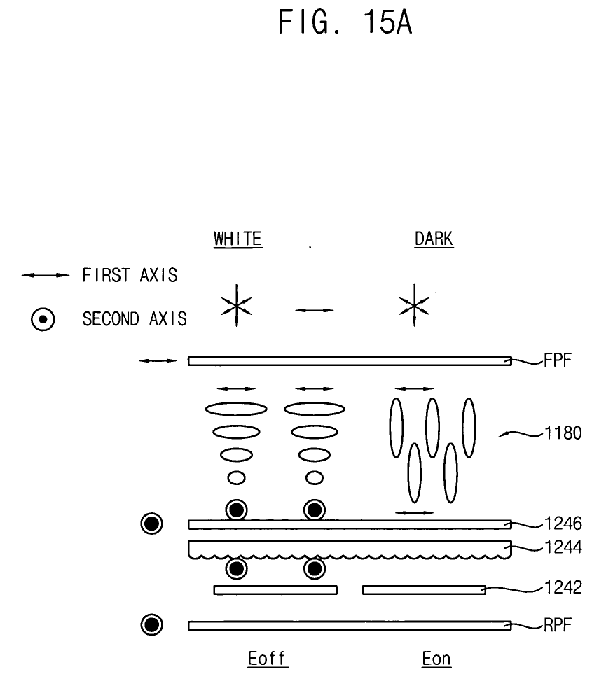

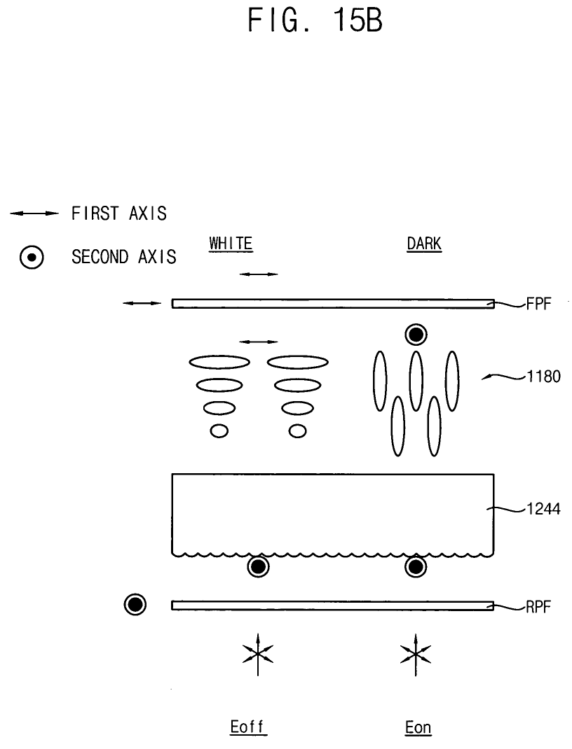

FIGS. 15A and 15B are conceptual views illustrating a light path of the LCD apparatus in FIG. 14. Hereinafter, a ‘first axis’ is defined as an axis that is disposed on a paper of drawings, and a ‘second axis’ is defined as an axis that is substantially parallel with a normal line of the paper.

Reflective Mode Operation

FIG. 15A corresponds to the reflective mode of the transflective LCD apparatus in FIG. 14.

Referring to FIG. 15A, when external light advances toward the second polarization plate FPF, a portion of this light oscillates along the first axis and passes through the second polarization plate FPF, and the remaining portion of the light is blocked by the second polarization plate FPF. If no electric fields are applied to the liquid crystal layer 1180 (Eoff), a portion of the light passes through the liquid crystal layer 1180 and is rotated to oscillate along the second axis. The portion of the light that oscillates along the second axis passes through the inner polarization layer 1250, because the inner polarization layer 1250 has a polarization axis that is substantially perpendicular to a polarization axis of the second polarization plate FPF. Further, the portion of light that passes through the inner polarization layer 1250 passes through the planarization layer 1246, so that the portion of the light is reflected by the reflective plate 1242 and passes through the planarization layer 1246 and the inner polarization layer 1250 in sequence. The portion of the light that exits from the inner polarization layer 1250 enters the liquid crystal layer 1180. When the portion of the light exits from the liquid crystal layer 1180, this portion of the light is rotated by the liquid crystal layer 1180 to pass through the second polarization plate FPF, thereby resulting in white color being displayed.

When electric fields are applied to the liquid crystal layer 1180 (Eon), the arrangement of liquid crystal molecules in the liquid crystal layer 1180 is changed, so that the portion of light that passes through the second polarization plate FPF passes through the liquid crystal layer 1180 without being rotated. As a result, the portion of light that passes through the liquid crystal layer 1180 without being rotated is blocked by the inner polarization layer 1250, so that the reflective plate 1242 does not reflect light, thereby resulting in black color being displayed.

Transmissive Mode Operation

FIG. 15B corresponds to the transmissive mode of the transflective LCD apparatus in FIG. 14.

Referring to FIG. 15B, light generated from a backlight assembly advances toward the first polarization plate RPF. A portion of that light oscillates along the second axis and passes through the first polarization plate RPF. The remaining portion of the light is blocked by the first polarization plate RPF. If no electric fields are applied to the liquid crystal layer 1180 (Eoff), a portion of the light passes through the liquid crystal layer 1180 and is rotated to oscillate along the first axis. The portion of the light that oscillates along the first axis passes through the second polarization plate FPF, because the second polarization plate FPF has a polarization axis that is substantially perpendicular to a polarization axis of the first polarization plate RPF, thereby also resulting in a white color being displayed.

When electric fields are applied to the liquid crystal layer 1180 (Eon), the arrangement of liquid crystal molecules in the liquid crystal layer 1180 is changed, so that the portion of light that passes through the first polarization plate RPF passes through the liquid crystal layer 1180 without being rotated. As a result, the portion of light that passes through the liquid crystal layer 1180 without being rotated is blocked by the second polarization plate FPF, so that black color is displayed.

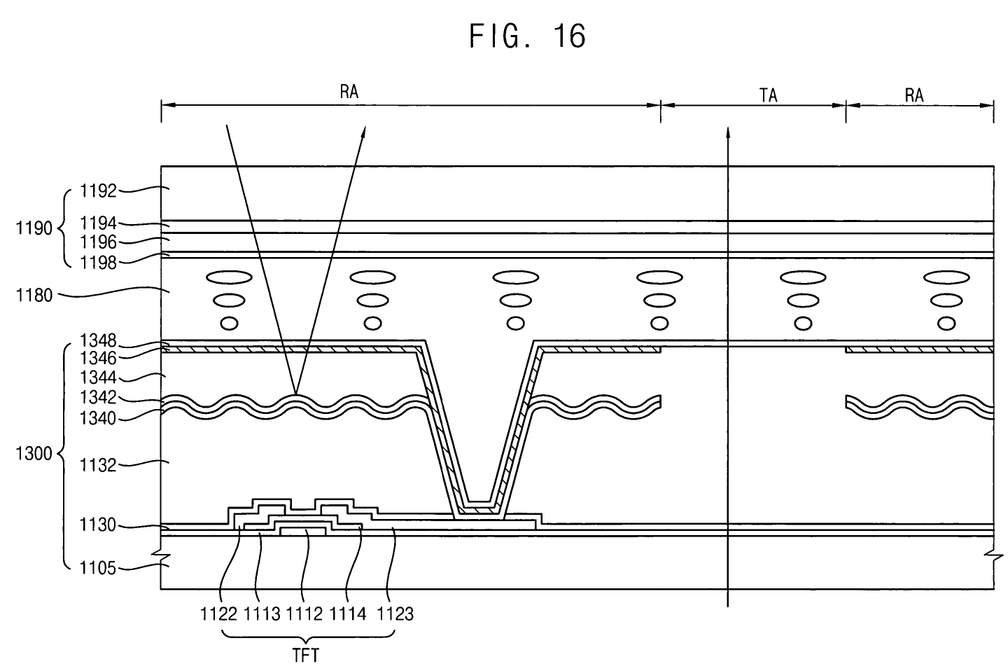

FIG. 16 is a cross-sectional view illustrating an LCD apparatus according to an exemplary embodiment of the present invention.

Referring to FIG. 16, an LCD panel includes an array substrate 1300, a liquid crystal layer 1180 and a color filter substrate 1190. The array substrate 1300 and the color filter substrate 1190 are combined with each other, and the liquid crystal layer 1180 is disposed between the array substrate 1300 and the color filter substrate 1190. Moreover, a first polarization plate is disposed on a lower surface of the array substrate 1300 and a second polarization plate is disposed on an upper surface of the color filter substrate 1190. The first and second polarization plates have different polarization axes. For example, the first polarization plate has a polarization axis that is substantially perpendicular to a polarization axis of the second polarization plate. The LCD panel of the present exemplary embodiment is same as the previous exemplary embodiment depicted in FIGS. 12-13B except for the array substrate 1300. Thus, the same reference numerals will be used to refer to the same or like parts as those described in the exemplary embodiment depicted in FIGS. 12-13B and any further explanation concerning the above elements will be omitted.

The array substrate 1300 includes a buffer metal layer 1340, a reflective plate 1342, a planarization layer 1344, an inner polarization layer 1346 and a pixel electrode layer 1348. The buffer metal layer 1340 is formed on an organic insulation layer 1132 having embossing patterns. The buffer metal layer 1340 is electrically connected to a drain electrode 1123 through a contact hole of the organic insulation layer 1132. The buffer metal layer 1340 is disposed at the reflective region RA. The reflective plate 1342 is formed on the buffer metal layer 1340 of the reflective region RA. The planarization layer 1344 is formed on the reflection plate 1342 of the reflective region RA and the organic insulation layer 1132 of the transmissive region TA. The inner polarization layer 1346 is formed on the planarization layer 1344 of the reflective region RA. The pixel electrode layer 1348 is formed on the inner polarization layer 1346 of the reflective region RA and the planarization layer 1344 of the transmissive region TR. The pixel electrode layer 1348 is electrically connected to the buffer metal layer 1340 or the drain electrode 1123.

The ratio of optical refractivity of the planarization layer 1344 to optical refractivity of the organic insulation layer 1132 is in a range of about a half to about one. That is because when an optical difference between the planarization layer 1344 and the organic insulation layer 1132 increases, light-using efficiency is reduced.

The inner polarization layer 1346 has a polarization axis that is substantially parallel with a polarization axis of the first polarization plate which is disposed on the lower surface of the first transparent substrate 1105.

The color filter substrate 1190 includes a second transparent substrate 1192, a light blocking layer, a color filter layer 1194, an over coating layer 1196, and a common electrode layer 1198. The light blocking layer is formed on the second transparent substrate 1192 and may include a plurality of openings arranged in a matrix type shape. Each of the openings defines a pixel. The color filter layer 1194 is formed on the second transparent substrate 1192 exposed through the openings of the light blocking layer. The over coating layer 1196 is formed on the color filter layer 1194. The common electrode layer 1198 is formed on the over coating layer 1196. The color filter substrate 1190 may further include a second alignment layer formed on the common electrode layer 1198.

The color filter substrate 1190 is combined with the array substrate 1100 such that the liquid crystal layer 1180 is disposed between the color filter substrate 1190 and the array substrate 1100. The liquid crystal layer has a single cell gap.

According to the present exemplary embodiment, the organic insulation layer 1132 includes a photosensitive material, so that the contact hole is easily formed through a photolithography process.

When the LCD panel does not require a contact hole, the organic insulation layer 1132 may instead include a material that is not photosensitive.

According to the present exemplary embodiment, the inner polarization layer 1346 is formed on the planarization layer 1344, and the pixel electrode layer 1348 is formed on the inner polarization layer 1346 in sequence. In other words, the pixel electrode layer 1348 is disposed between the first alignment layer and the inner polarization layer 1346.

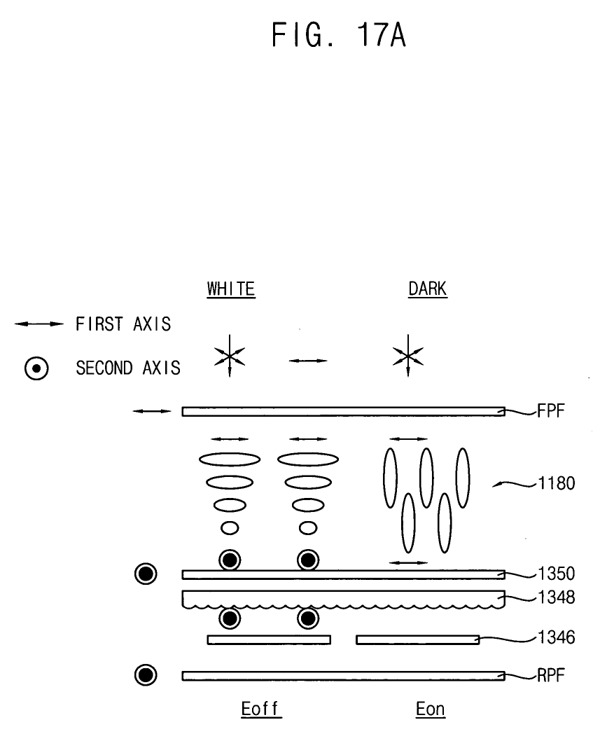

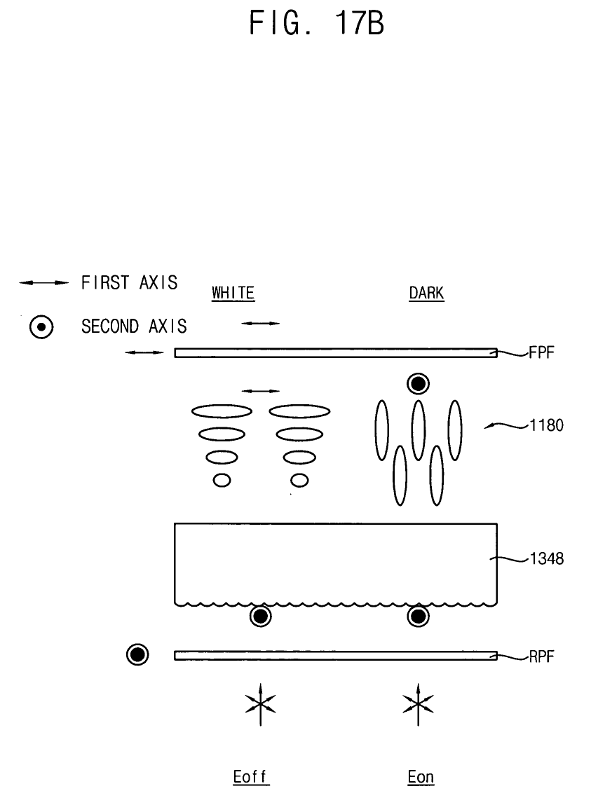

FIGS. 17A and 17B are conceptual views illustrating a light path of the LCD apparatus in FIG. 16. Hereinafter, a ‘first axis’ is defined as an axis that is disposed on a paper of drawings, and a ‘second axis’ is defined as an axis that is substantially parallel with a normal line of the paper.

Reflective Mode Operation

FIG. 17A corresponds to the reflective mode of the transflective LCD apparatus in FIG. 16.

Referring to FIG. 17A, when external light advances toward the second polarization plate FPF. A portion of that light oscillates along the first axis and passes through the second polarization plate FPF, and the remaining portion of the light is blocked by the second polarization plate FPF. If no electric fields are applied to the liquid crystal layer 1180 (Eoff), a portion of the light passes through the liquid crystal layer 1180 and is rotated to oscillate along the second axis. The portion of the light that oscillates along the second axis passes through the inner polarization layer 1346, because the inner polarization layer 1346 has a polarization axis that is substantially perpendicular to a polarization axis of the second polarization plate FPF. The portion of light that passes through the inner polarization layer 1346 passes through the planarization layer 1344, so that the portion of the light is reflected by the reflective plate 1342 and passes through the planarization layer 1344 and the inner polarization layer 1344 in sequence. The portion of the light that exits from the inner polarization layer 1344 enters the liquid crystal layer 1180. When the portion of the light that exits from the liquid crystal layer 1180, this portion of the light is rotated by the liquid crystal layer 1180 to pass through the second polarization plate FPF, thereby resulting in white color being displayed.

When electric fields are applied to the liquid crystal layer 1180 (Eon), the arrangement of liquid crystal molecules in the liquid crystal layer 1180 is changed, so that the portion of light that passes through the second polarization plate FPF passes through the liquid crystal layer 1180 without being rotated. Therefore, the portion of light that passes through the liquid crystal layer 1180 without being rotated is blocked by the inner polarization layer 1346, so that the reflective plate 1342 does not reflect light, thereby resulting in black color being displayed.

Transmissive Mode Operation

FIG. 17B corresponds to the transmissive mode of the transflective LCD apparatus in FIG. 16.

Referring to FIG. 17B, light generated from a backlight assembly advances toward the first polarization plate RPF. A portion of that light oscillates along the second axis and passes through the first polarization plate RPF, and the remaining portion of the light is blocked by the first polarization plate RPF. If no electric fields are applied to the liquid crystal layer 1180 (Eoff), a portion of the light passes through the liquid crystal layer 1180 and is rotated to oscillate along the first axis. The portion of the light that oscillates along the first axis passes through the second polarization plate FPF, because the second polarization plate FPF has a polarization axis that is substantially perpendicular to a polarization axis of the first polarization plate RPF, thereby also resulting in white color being displayed.

When electric fields are applied to the liquid crystal layer 1180 (Eon), the arrangement of liquid crystal molecules in the liquid crystal layer 1180 is changed, so that the portion of light that passes through the first polarization plate RPF passes through the liquid crystal layer 1180 without being rotated. As a result, the portion of light that passes through the liquid crystal layer 1180 without being rotated is blocked by the second polarization plate FPF, so that black color is displayed.

According to the exemplary embodiments of the present invention, the inner polarization layer is formed at the reflective region inside of the LCD panel having a single cell gap structure. For example, the inner polarization layer may be disposed between the reflective plate and the liquid crystal layer.

Additionally, the pixel electrode layer and the inner polarization layer may be formed through the same photo process to simplify the method of manufacturing the transfiective LCD panel. For instance, after the pixel electrode layer is formed, the inner polarization layer is coated on the pixel electrode layer, and then the pixel electrode layer and the inner polarization layer are patterned by a slit mask or a half-tone mask. Thus, productivity is enhanced.

Moreover, the inner polarization layer may be formed on a planarization layer having flat surface, so that light leakage caused by a curved surface is prevented. To enhance optical reflectivity, the planarization layer is formed on the reflective plate having an embossing pattern. In addition, a thin crystal film is formed on the planarization layer having flat surface, for example through slot die coating method, so that the inner polarization layer having the flat surface is formed.

In addition, the pixel electrode layer may be formed on the planarization layer and the inner polarization layer may be formed on the pixel electrode layer. In other words, the pixel electrode layer may be disposed between the planarization layer and the inner polarization layer to enhance manufacturing stability.

Still further, the inner polarization layer may be formed on the planarization layer and the pixel electrode layer may be formed on the inner polarization layer. In other words, the pixel electrode layer is disposed between the first alignment layer and the inner polarization layer to enhance stability of liquid crystal layer.

Having described the exemplary embodiments of the present invention and its advantages, it is further noted that it is readily apparent to those of reasonable skill in the art that various modifications can be made herein without departing from the spirit and scope of the invention which is defined by the metes and bounds of the appended claims.

What is claimed is:

1. An array substrate comprising:
a transparent substrate having a reflective region and a transmissive region;
a switching device formed in the reflective region;
an insulation layer formed on the transparent substrate to cover the switching device, the insulation layer having a contact hole that exposes a portion of an electrode of the switching device;
a pixel electrode that is electrically connected to the electrode of the switching device through the contact hole;
a reflective plate that is electrically connected to the pixel electrode, the reflective plate disposed on the reflective region; and
an inner polarization layer that covers the reflective plate.

2. The array substrate of claim 1, wherein an upper surface of the insulation layer has a substantially same height throughout the reflective and transmittive regions with respect to the transparent substrate.

3. The array substrate of claim 1, further comprising a planarization layer formed on the reflective plate having embossing patterns.

4. The array substrate of claim 3, wherein the inner polarization layer is formed on the planarization layer.

5. The array substrate of claim 1, wherein the reflective plate comprises a plurality of protruded portions and a plurality of recessed portions.

6. The array substrate of claim 5, further comprising a planarization layer disposed between the reflective plate and the inner polarization layer.

7. The array substrate of claim 1, wherein the inner polarization layer has a flat surface.

8. An array substrate comprising:
a substrate;
a switching device formed on the substrate, the switching device comprising a gate electrode, a source electrode and a drain electrode;
a transparent electrode layer that is electrically connected to the drain electrode of the switching device;
a reflective plate that is electrically connected to the drain electrode;
a planarization layer formed on the reflective plate; and
an inner polarization layer formed on the planarization layer.

9. The array substrate of claim 8, wherein the inner polarization layer covers the reflective plate.

10. The array substrate of claim 8, wherein the planarization layer has a flat surface.

11. The array substrate of claim 8, further comprising a polarization plate having a polarization axis that is substantially parallel with a polarization axis of the inner polarization layer.

12. The array substrate of claim 8, wherein the transparent electrode layer is disposed between the planarization layer and the inner polarization layer.

13. The array substrate of claim 8, wherein the transparent electrode layer is formed on the inner polarization layer.

14. The array substrate of claim 8, further comprising a photosensitive insulation layer having embossing patterns and an optical transmittance of substantially equal to or more than about 90%.

15. The array substrate of claim 8, wherein the planarization layer has an optical transmittance of substantially equal to or more than about 90%.

16. A method of manufacturing an array substrate, comprising:
forming an insulation layer on a substrate having a switching device, the insulation layer having a contact hole that exposes a portion of a drain electrode of the switching device;
forming a transparent electrode layer that is electrically connected to the drain electrode through the contact hole;
forming a reflective plate that is electrically connected to the transparent electrode; and
forming an inner polarization layer on the reflective plate.

17. The method of claim 16, further comprising forming embossing patterns at the insulation layer.

18. The method of claim 16, further comprising forming a planarization layer on the reflective plate and forming an alignment layer having a uniform rubbing direction on the planarization and the inner polarization layer.

19. The method of claim 16, further comprising removing a portion of the reflective plate to form a transmissive window.

20. The method of claim 18, wherein the inner polarization layer is formed on the planarization layer.

21. A liquid crystal display (LCD) apparatus comprising:
a first substrate;
a second substrate combined with the first substrate, the second substrate including a reflective plate, a pixel electrode and a polarization layer covering the reflective plate; and
a liquid crystal layer disposed between the first and second substrates.

22. The LCD apparatus of claim 21, further comprising a first polarization plate that is disposed on an upper surface of the first substrate.

23. The LCD apparatus of claim 22, wherein a polarization axis of the polarization layer is substantially perpendicular to a polarization axis of the first polarization plate.

24. The LCD apparatus of claim 21, further comprising a second polarization plate that is disposed on a lower surface of the second substrate.

25. The LCD apparatus of claim 24, wherein a polarization axis of the inner polarization layer is substantially perpendicular to a polarization axis of the first polarization plate.

26. The LCD apparatus of claim 21, wherein the reflective plate has relatively high portions and relatively low portions, and wherein the inner polarization layer is formed on the reflective plate to have a flat surface.

27. The LCD apparatus of claim 21, further comprising a planarization layer, wherein the reflective plate has relatively high portions and relatively low portions, the planarization layer is formed on the reflective plate to have flat surface, and wherein the inner polarization layer is formed on the planarization layer.

28. The LCD apparatus of claim 21, wherein the reflective plate has relatively high portions and relatively low portions, and wherein the inner polarization layer is formed on the reflective plate to have a uniform thickness.

29. The LCD apparatus of claim 21, wherein the inner polarization layer includes a disc type liquid crystal.

30. The LCD apparatus of claim 21, wherein the liquid crystal layer has a uniform cell gap.

31. The LCD apparatus of claim 21, wherein the liquid crystal layer comprises a twisted nematic liquid crystal configuration.

32. The LCD apparatus of claim 21, wherein the second substrate further comprises a planarization layer disposed between the reflective plate and the inner polarization layer.

33. A liquid crystal display (LCD) apparatus having a reflective region and a transmissive region, comprising:
a lower substrate comprising;
a substrate;
a switching device formed on the substrate, the switching device having a gate electrode, a source electrode and a drain electrode;
an insulation layer formed on the substrate to cover the switching device, the insulation layer having a contact hole that exposes a portion of the drain electrode of the switching device;
a reflective plate formed on the insulation layer of the reflective region such that the reflective plate is electrically connected to the drain electrode through the contact hole;
a planarization layer formed on the reflective plate of the reflective region, and the insulation layer of the transmissive region;
a transparent electrode layer formed on the planarization layer such that the transparent electrode is electrically connected to the drain electrode; and
an inner polarization layer formed on the transparent electrode layer of the reflective region to cover the reflective plate;
an upper substrate that faces the lower substrate; and
a liquid crystal layer disposed between the lower and upper substrate such that the liquid crystal layer has a uniform cell gap throughout the reflective and transmissive regions.

34. The LCD apparatus of claim 33, wherein the reflective plate has a flexuous surface.

35. The LCD apparatus of claim 33, wherein the upper substrate comprises color filters.

36. A liquid crystal display (LCD) apparatus comprising:
a lower substrate including:
a first transparent substrate;
a switching device formed on the first transparent substrate, the switching device having a gate electrode, a source electrode and a drain electrode;
a transparent electrode layer that is electrically connected to the drain electrode of the switching device;
a reflective plate that is electrically connected to the drain electrode of the switching device, the reflective plate having flexuous surface;
a planarization layer formed on the reflective plate, the planarization layer having a flat surface; and
an inner polarization layer formed on the planarization layer;
an upper substrate combined with the lower substrate; and
a liquid crystal layer disposed between the lower and upper substrates.

37. The LCD apparatus of claim 36, wherein the inner polarization layer covers the reflective plate.

38. The LCD apparatus of claim 36, wherein the liquid crystal layer has a uniform cell gap.

39. The LCD apparatus of claim 36, further comprising a first polarization plate disposed on a lower surface of the lower substrate, the first polarization plate having a polarization axis that is substantially parallel with a polarization axis of the inner polarization layer.

40. The LCD apparatus of claim 36, further comprising a second polarization plate disposed on an upper surface of the upper substrate, the second polarization plate having a polarization axis that is substantially perpendicular to a polarization axis of the inner polarization layer.

41. The LCD apparatus of claim 36, wherein the transparent electrode layer is disposed between the planarization layer and the inner polarization layer.

42. The LCD apparatus of claim 36, wherein the transparent electrode layer is formed on the inner polarization layer.

43. The LCD apparatus of claim 36, further comprising a photosensitive insulation layer having embossing patterns and an optical transmittance of substantially equal to or more than about 90%.

44. The LCD apparatus of claim 36, wherein the planarization layer has an optical transmittance of substantially equal to or more than about 90%.
